(19) United States
(12) Patent Application Publication
(10) Pub. No.: US 2006/0205580 A1
(43) Pub. Date: Sep. 14, 2006

(54) Paper folding device, finisher, and image forming apparatus

(76) Inventors: Noriaki Sekine, Saitama (JP); Toshiaki Tobishima, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/373,256

(22) Filed: Mar. 13, 2006

(30) Foreign Application Priority Data
Mar. 14, 2005 (JP) 2005-071704 (JP)
Jan. 23, 2006 (JP) 2006-014098 (JP)
Jul. 5, 2005 (JP) 2005-196390 (JP)

(51) Int. Cl. B31F 1/00

(52) U.S. Cl. 493/421

(57) ABSTRACT

A paper folding device having a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one (lower side) folding roller of the folding roller pair on a side where the paper folds, and the paper to be folded is carried and folded. When paper is caused to enter a nip of the left folding roller pair by the left shifting device, tension is applied to the paper by a right shifting device. Thus, the angle at which the paper winds onto upper side folding rollers is adjusted.

### BACKGROUND OF THE INVENTION

1. Field of the Invention

The present invention relates to paper folding devices having a function of being capable of folding paper a plurality of times, finishers provided with this paper folding device, and image forming apparatuses such as copying machines, printers, facsimile machines, or digital multifunction devices, provided with this paper folding device or finisher.

2. Description of the Background Art

Paper folding devices such as those disclosed in Japanese Patent Application Laid-open No. 2004-67266 (hereinafter referred to as Prior Art 1) and Japanese Patent No. 3,356,851 (hereinafter referred to as Prior Art 2) are known as examples of devices that have two pairs of folding rollers that bend paper, a pair of carry rollers that feed paper to either of the roller pairs, and a biasing means that switches a direction in which the paper bends to either of the folding rollers, and are capable of alternately switching the bending direction to fold paper continuously a plurality of times. These devices have biasing means that push a central portion of the paper toward a rolling position at a nip of the folding rollers.

However, as is described later, in these conventional paper folding devices, there is large unevenness in folding positions due to thick papers and thin papers, and unevenness in the folding positions for single folds and multiple folds, and therefore there have been problems of having low folding accuracy and unstable folding functions.

### SUMMARY OF THE INVENTION

The present invention has been devised in consideration of these problems and it is an object thereof to provide a paper folding device that greatly reduces unevenness in folding positions due to thick papers and thin papers as well as unevenness in the folding positions for single folds and multiple folds, and can achieve folding functions with high folding accuracy and stability.

Another object of the present invention is to provide a finisher provided with this paper folding device.

Another object of the present invention is to provide an image forming apparatus provided with this paper folding device or finisher.

In an aspect of the present invention, a paper folding device has a function of alternately switching a bending direction to carry out folding continuously a plurality of times and comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one folding roller of the folding roller pair on a side where the paper folds, and the paper to be folded is carried and folded.

In another aspect of the present invention, a paper folding device has a function of alternately switching a bending direction to carry out folding continuously a plurality of times and comprises first and second pairs of folding roller pairs that bend a paper; a carry roller pair that feeds the paper to the first or second folding roller pair; and a biasing device for switching a direction in which the paper is bent by the first or second folding roller pair. The paper is brought into contact with one folding roller of the folding roller pair on a side where paper is folded while the biasing device applies a fixed tension to the paper, and the paper to be folded is carried and folded.

In another aspect of the present invention, a paper folding device has a function of alternately switching a bending direction to carry out folding continuously a plurality of times and comprises first and second pairs of folding roller pairs that bend a paper; a carry roller pair that feeds the paper to the first or second folding roller pair; and a biasing device for switching a direction in which the paper is bent by the first or second folding roller pair. Both ends of the biasing device are driven so that movement amounts of both ends of the biasing device become equivalent, and the paper is brought into contact with one folding roller of the folding roller pair on a side where paper is folded such that the paper to be folded is carried and folded.

In another aspect of the present invention, a paper folding device has a function of alternately switching a bending direction to carry out folding continuously a plurality of times and comprises first and second pairs of folding roller pairs that bend a paper; a carry roller pair that feeds the paper to the first or second folding roller pair; and a biasing device for switching a direction in which the paper is bent by the first or second folding roller pair. The biasing device supports and carries the paper to be folded in a state having a gap equal to or greater than one sheet of paper with respect to one folding roller of the folding roller pair on a side where the paper folds.

In another aspect of the present invention, a finisher provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one folding roller of the folding roller pair on a side where the paper folds, and the paper to be folded is carried and folded.

In another aspect of the present invention, a finisher provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one folding roller of the folding roller pair on a side where the paper folds while applying a fixed tension to the paper, and the paper to be folded is carried and folded.

In another aspect of the present invention, a finisher provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. Both ends of the biasing device are driven so that movement amounts of become equivalent, and the paper is brought into contact with one folding roller of the folding roller pair on a side where paper is folded such that the paper to be folded is carried and folded.

In another aspect of the present invention, a finisher provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device supports and carries the paper to be folded in a state having a gap equal to or greater than one sheet of paper with respect to one folding roller of the folding roller pair on a side where the paper folds.

In another aspect of the present invention, an image forming apparatus provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one folding roller of the folding roller pair on a side where the paper folds, and the paper to be folded is carried and folded.

In another aspect of the present invention, an image forming apparatus provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device brings the paper into contact with one folding roller of the folding roller pair on a side where the paper folds while applying a fixed tension to the paper, and the paper to be folded is carried and folded.

In another aspect of the present invention, an image forming apparatus provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. Both ends of the biasing device are driven so that movement amounts of both ends of the biasing device become equivalent, and the paper is brought into contact with one folding roller of the folding roller pair on a side where paper is folded such that the paper to be folded is carried and folded.

In another aspect of the present invention, an image forming apparatus provided with a paper folding device has a function of alternately switching a bending direction to carry out folding continuously a plurality of times. The paper folding device comprises first and second pairs of folding roller pairs that bend a paper; a carry roller pair that feeds the paper to the first or second folding roller pair; and a biasing device for switching a direction in which the paper is bent by the first or second folding roller pair. The biasing device supports and carries the paper to be folded in a state having a gap equal to or greater than one sheet of paper with respect to one folding roller of the folding roller pair on a side where the paper folds.

In another aspect of the present invention, a paper folding device comprises a folding roller pair that folds a paper; a carry roller pair that feeds the paper to the folding roller pair; a biasing device for switching a direction in which the paper is bent by the folding roller pair and folding in the paper; and a tension applying device that applies tension to the paper folded between the folding roller pair and the carry roller pair.

In another aspect of the present invention, a finisher is provided with a paper folding device. The paper folding device comprises a folding roller pair that folds a paper; a carry roller pair that feeds the paper to the folding roller pair; a biasing device for switching a direction in which the paper is bent by the folding roller pair and for folding in the paper; and a tension applying device that applies tension to the paper folded between the folding roller pair and the carry roller pair.

In another aspect of the present invention, an image forming apparatus is provided with a paper folding device. The paper folding device comprises a folding roller pair that folds a paper; a carry roller pair that feeds the paper to the folding roller pair; a biasing device for switching a direction in which the paper is bent by the folding roller pair and for folding in the paper; and a tension applying device that applies tension to the paper folded between the folding roller pair and the carry roller pair.

### BRIEF DESCRIPTION OF THE DRAWINGS

The above and other objects, features, and advantages of the present invention will become more apparent from the following detailed description taken with the companying drawings in which:

FIGS. 1A to 1C are diagrams for describing one example operation of a conventional technique;

FIG. 2 is a diagram for describing another example operation of a conventional technique;

FIG. 3 is a lateral view showing a system structure of a copying machine main unit and a paper folding device according to a first embodiment of the present invention;

FIGS. 4 to 7 are diagrams for describing an operation of a paper folding device according to the first embodiment;

FIG. 8 shows a drive means configuration according to the first embodiment;

FIG. 9 shows a biasing means configuration according to the first embodiment;

FIG. 10 shows a rail groove structure of the biasing means;

FIG. 11 is a perspective view showing a pressure applying mechanism of a central portion of the folding rollers;

FIG. 12 is a block diagram showing a configuration of a control system according to the first embodiment;

FIGS. 13A to 13D and 14A to 14D are flowcharts showing a processing procedure according to the first embodiment;

FIGS. 15 to 17 are diagrams for describing operations of the folding rollers according to the first embodiment;

FIG. 18 is a perspective view showing an embodiment of a drive mechanism of the biasing means according to the first embodiment:

FIG. 19 is a perspective view showing a configuration of a jam processing mechanism of the biasing means according to the first embodiment;

FIGS. 20 to 23 are diagrams for describing operations of a paper folding device according to a second embodiment of the present invention;

FIG. 24 shows a configuration of a biasing means according to the second embodiment;

FIG. 25 shows a configuration of rail grooves of the biasing means according to the second embodiment;

FIGS. 26A and 26B are perspective views showing a form of a leading edge portion of the biasing means according to the second embodiment;

FIGS. 27 to 29 are diagrams for describing an operation of folding rollers according to the second embodiment;

FIG. 30 is a diagram for describing an operation of a paper folding device according to a modification of the second embodiment;

FIG. 31 is a diagram for describing an adjustment operation (when one shaft is fixed) of a biasing means of a paper folding device according to a third embodiment of the present invention;

FIG. 32 is a diagram for describing an adjustment operation (when two shaft are fixed) of the biasing means of the paper folding device according to the third embodiment;

FIG. 33 is a diagram for describing a problematic point when accordion folded paper is cross folded;

FIG. 34 is a lateral view showing a system configuration of a copying machine main unit and a paper folding device according to a fourth embodiment of the present invention;

FIG. 35 is a view along an A direction arrow in FIG. 34;

FIG. 36 shows unevenness in a stopping position of paper in the case of accordion folding and a state of correction control thereof according to a fifth embodiment of the present invention;

FIGS. 37A to 37D are flowcharts showing a processing procedure for correcting unevenness in the stopping position of paper in the case of accordion folding according to the fifth embodiment of the present invention;

FIG. 38 is a flowchart showing a processing procedure according to a sixth embodiment of the present invention; and

FIGS. 39 to 41 are diagrams for describing operations of a paper folding device according to this embodiment.

### DESCRIPTION OF THE PREFERRED EMBODIMENTS

Before describing embodiments of the present invention, prior art and problems thereof are described with reference to the accompanying drawings.

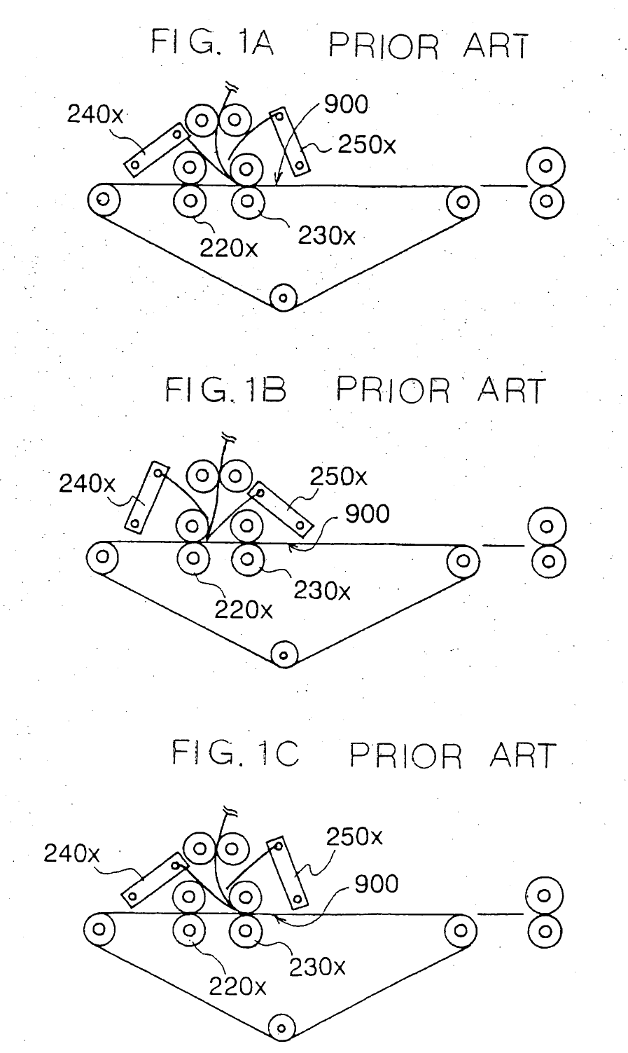

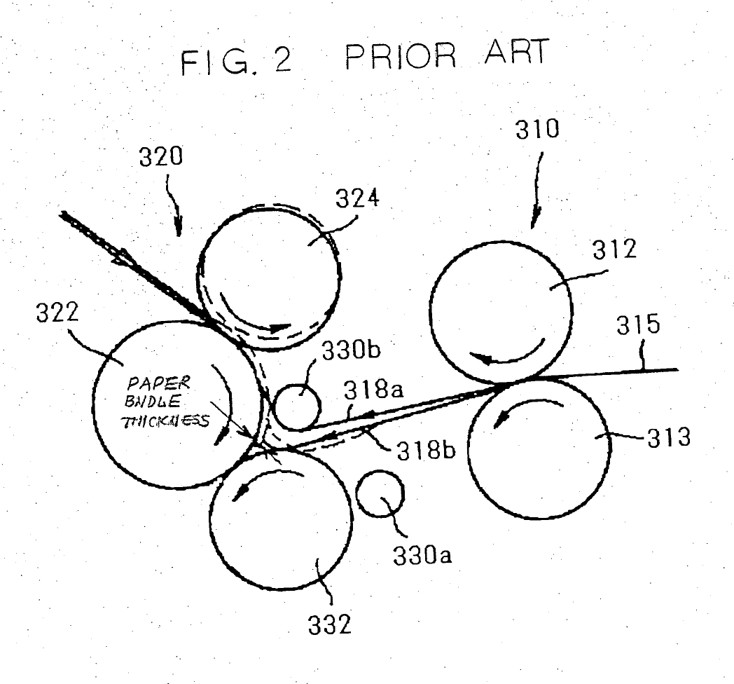

As stated above, paper folding devices that have two pairs of folding rollers that bend paper, a pair of carry rollers that feed paper to either of the roller pairs, and a biasing means that switches a direction in which the paper bends to either of the folding rollers, and are capable of alternately switching the bending direction to fold paper continuously a plurality of times are disclosed in the above-mentioned Prior Art 1 and Prior Art 2 for example. These conventional paper folding devices have biasing means that push a central portion of the paper toward a rolling position at a nip of the folding rollers. That is, the biasing means of the paper folding device disclosed in Prior Art 1 is indicated by folding knives 240x and 250x in FIGS. 1A to 1C, and the biasing means of the paper folding device disclosed in Prior Art 2 is indicated by pushing rollers 330a and 330b in FIG. 2.

To describe this more specifically, repetition of an operation is described in Prior Art 1 in which, after the leading edge area of a paper 900 that has been fed as shown in FIG. 1A has been gripped between an upper roller and a lower roller of a second folding roller pair 230x for example (at this time, the folding knife 240x guides the leading edge area of the paper 900), an area that is to become the first fold of a zigzag shape fold of the paper 900 is guided by the folding knife 250x and gripped between an upper roller and a lower roller of a first folding roller pair 220x as shown in FIG. 1B, and then a portion that is to become the next fold of the zigzag shape fold of the paper 900 is guided by the folding knife 240x as shown in FIG. 1C and gripped between an upper roller and a lower roller of a second folding roller pair 230x.

On the other hand, it is described in Prior Art 2 that, for the case of folding up a sheet, after a sheet 315 passes between the rollers 322 and 324 in FIG. 2 for example by a predetermined length, a half rotation clutch is operated to move a driven roller 313 and push rollers 330a and 330b to a first position, and the sheet 315 between a carry roller pair 310, which is constituted by a driving roller 312 and the driven roller 313, and a folding roller group 320 (322, 323, and 332) is pushed toward the rollers 322 and 332 by a push roller 330b as shown by numeral 318a, thereby creating a flexure in the sheet 315, and the folding rollers 322 and 324 are rotated forward so that a flexed portion of the sheet 315 as shown by numeral 318b is clenched in the rollers 320 and 323 to form a fold. Then it is disclosed that the sheet 315 can be folded in this manner, after which the half rotation clutch is operated as required in the same manner to carry out multiple folding of the sheet 315.

However, in the case of these conventional paper folding devices, the biasing means is moved close to the two respective pairs of folding rollers, but the folding rollers and the paper do not contact directly. Thus, the paper flexes in a circular arc shape from a position where the central portion of the paper is stopped being pushed toward the rolling position, the folding roller pairs and the paper come in contact, and the paper gripped in the nip of the folding rollers is folded. The paper flexes in a circular arc shape and a force by which the paper contacts the folding rollers when the folding roller pair and the paper come in contact is only a restoring force due to the rigidity of the paper (a force of returning from a flexed state to a flat state). Consequently, a carrying force of the folding rollers when the paper flexes and comes in contact with the folding roller pair varies according to the rigidity of the paper, that is, the thickness of the paper (ordinarily the thicker a paper is, the greater its rigidity).

In fact, a resistant force is produced when the paper changes from a flexed state to a state in which it buckles and folds. When this resistant force is strong, the carrying force of the folding rollers when the paper flexes and comes into contact with the folding roller pair is overcome and slippage occurs such that the paper flexes more between the folding rollers and the carry rollers, finally causing unevenness in the folding positions due to the thickness of the paper.

Further still, when folding is repeated multiple times for multiple folding, a paper bundle (dashed line portion) forms on a lower surface side of the paper flexed in a circular arc shape as in FIG. 2. The form of the paper flexed in a circular arc shape at this time is a form such as that shown by the dashed line in FIG. 2 and naturally is different than a flexed form of a single fold. Since the contact position of the folding roller pair and the paper varies at this time, the amount of slippage between the folding rollers and the paper due to the resistant force when the paper buckles and goes into a folded state further varies. That is, there is further unevenness in the folding positions. Also, as for the thickness of the paper bundle (dashed line portion) when folding at the same width, the fold of the paper, that is, the vicinity of the peak where the paper flexes, bulges the most and tends to vary. This is because the thicknesses of the folds vary greatly since the paper bundles form thickly and the paper bundles form thinly due to thick papers and thin papers.

Due to this, the contact positions of the folding roller pairs and the paper further varies, and therefore the amount of slippage between the folding rollers and the paper due to the resistant force when the paper buckles and goes into a folded state varies even more. That is, there is further unevenness in the folding positions.

The following are detailed descriptions, with reference to the accompanying drawings, of embodiments of the present invention that solve the above-described problems of conventional techniques.

### First Embodiment

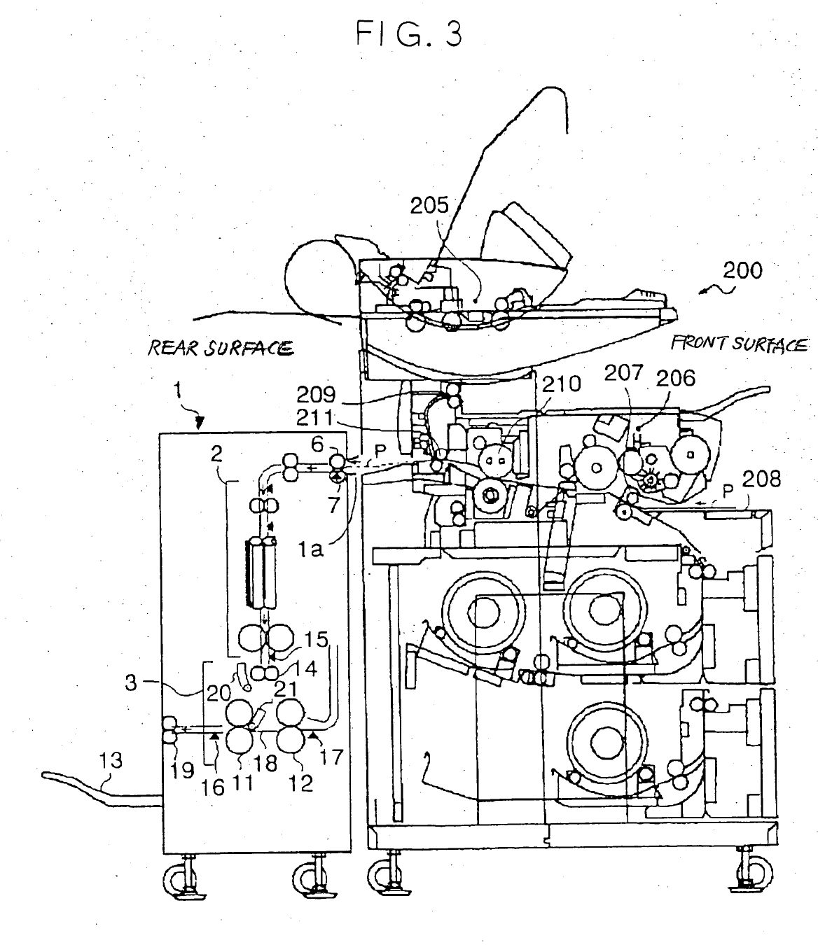

FIG. 3 shows an overall outlined structure of a system of an image forming apparatus according to a first embodiment of the present invention. As shown in the diagram, the system is constituted by a copying machine main unit 200 and a paper folding device 1, with the paper folding device 1 linked to a rear surface of the copying machine main unit 200 and being capable of end surface folding and accordion folding of sheets. The paper folding device 1 is constituted by a linking portion la that links with the main unit, an end surface folding portion 2 that folds an end surface of a leading edge of a sheet, a paper folding portion 3 that folds a sheet in an accordion shape in a carrying direction, and a tray 13 into which folded sheets are discharged and stacked.

An image reading apparatus 205 is arranged in the copying machine main unit 200 and a manual feed platform 208 is arranged thereunder. When paper is loaded into the manual feed platform 208, the paper is temporarily stopped at a nip of a register roller 207 then fed into an image forming unit 206 with an appropriate timing. The image forming unit 206 forms a latent image on an unshown photosensitive body corresponding to image data, this latent image is developed using toner, the toner is transferred to the paper and fixed using a fixing apparatus 210. When a recorded sheet on which toner has been fixed by the fixing apparatus 210 is to undergo paper folding, the recorded sheet is discharged to the paper folding device 1 by a recorded sheet discharge roller 211. And when folding is not to be carried out, the paper is discharged to inside a main unit cylinder by an upper discharge roller 209 due to an unshown switching claw.

Next, when the paper is to be folded, the paper is sent to the paper folding device 1 by the recorded sheet discharge roller 211, the paper is sent by entrance carrying roller pairs 6 and 7, and when an end surface of the paper is to be folded, an end surface of the leading edge of the paper is folded by the end surface folding portion 2. After the end surface of the leading edge of the paper has been folded by the end surface folding portion 2, the paper is folded into an accordion shape in the carrying direction by the paper folding portion 3 and the folded paper is stacked in the tray 13.

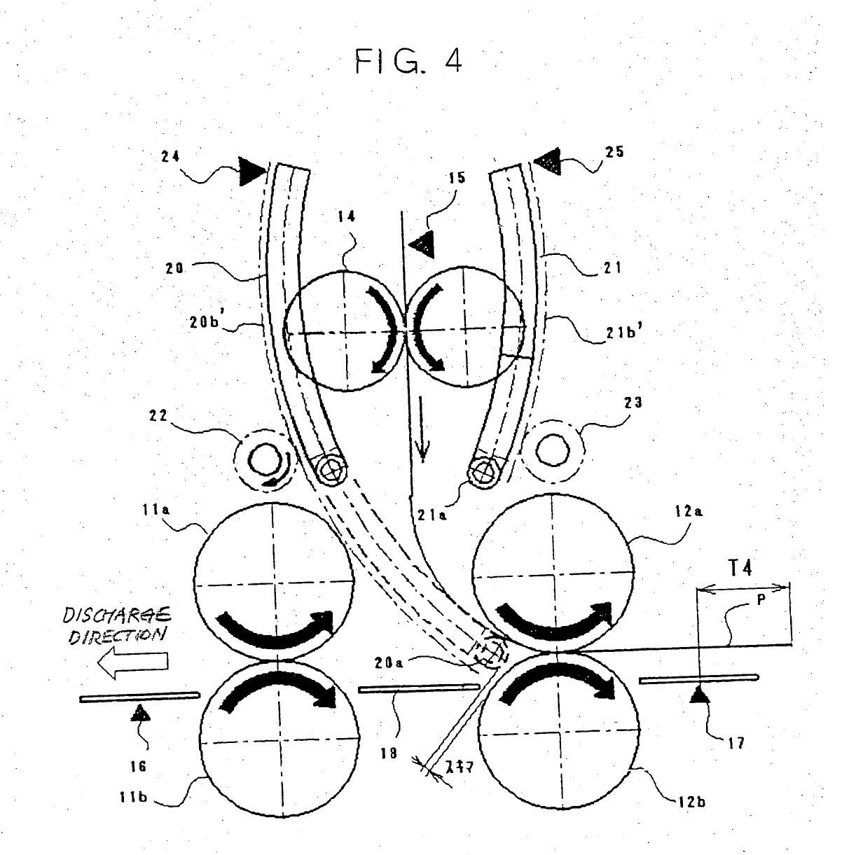

The paper folding portion 3 has a function of folding paper into an accordion shape with respect to the carrying direction. An enlargement of principle portions of the paper folding portion 3 of FIG. 3 is shown in FIG. 4.

In FIG. 4, a leading edge detection sensor 15 that detects the leading edge of a paper P is arranged at the entrance of the paper folding portion 3 and a pair of carry rollers 14 are provided on a downstream side thereof. On the downstream side of this, folding roller pairs 11 and 12 that carry paper in a perpendicular direction are arranged opposing the paper carrying direction in which paper is carried by the pair of carry rollers 14. The folding roller pairs 11 and 12 rotate forward or backward in synchronization and fold paper in an accordion shape. A paper width left sensor 16 and a paper width right sensor 17 are provided on outer sides of the folding roller pairs 11 (11a and 11b) and 12 (12a and 12b) and detect the leading edge of the paper and the folded end surface of a folded sheet. A lower guide plate 18 is arranged between the folding roller pairs 11 and 12 and guides the end surface of folded sheets to the roller pairs 11 and 12.

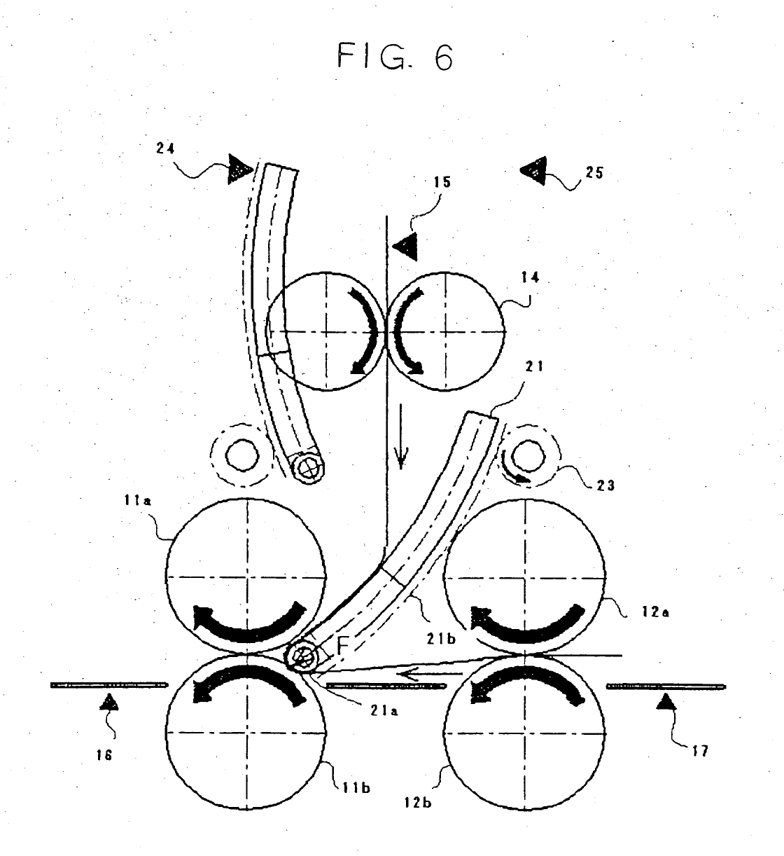

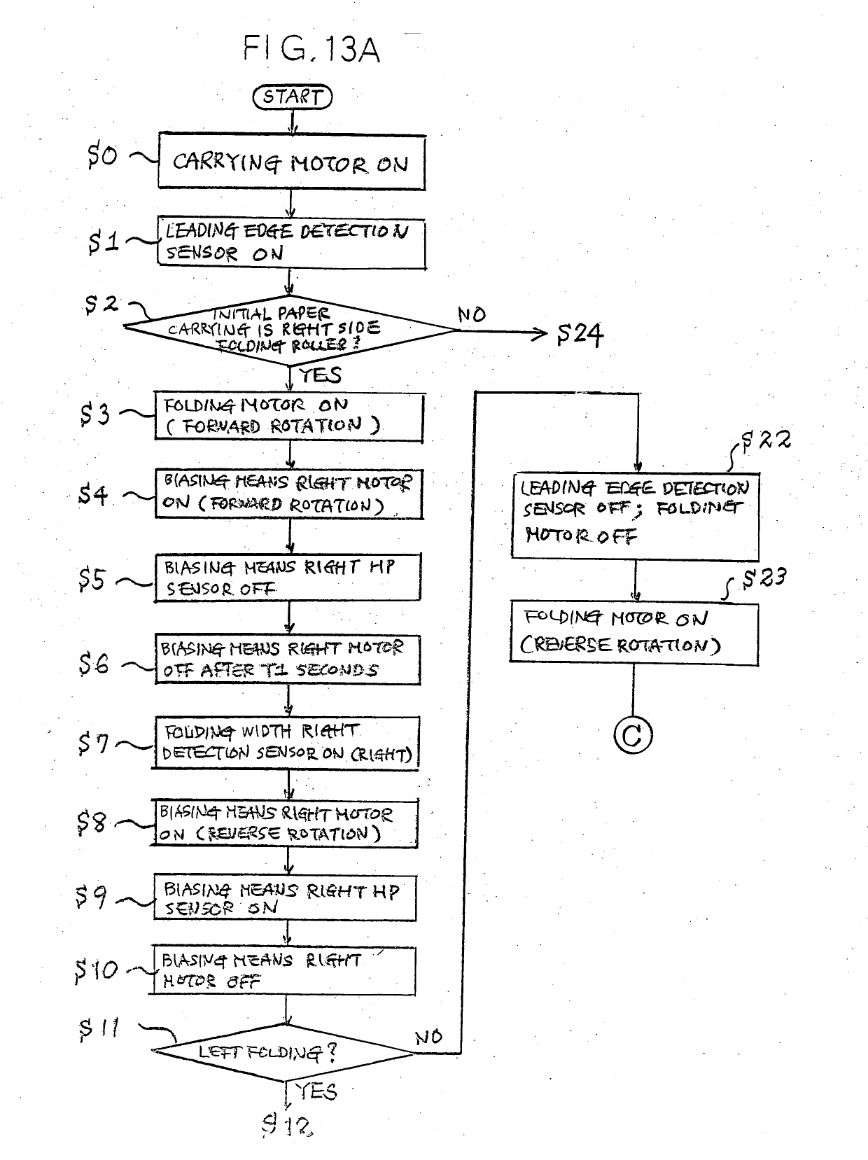

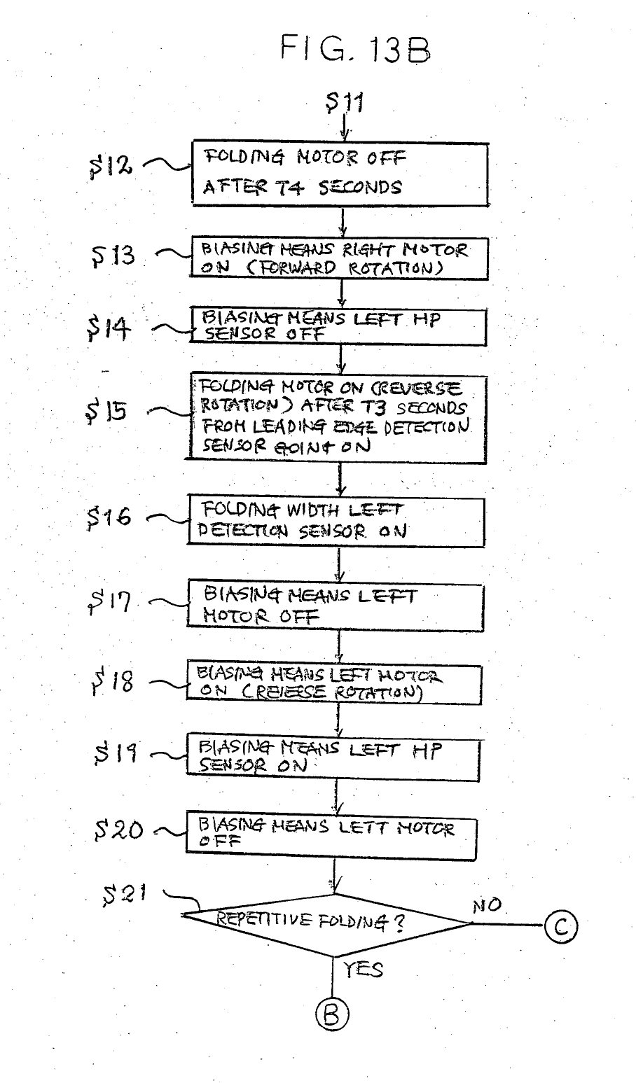

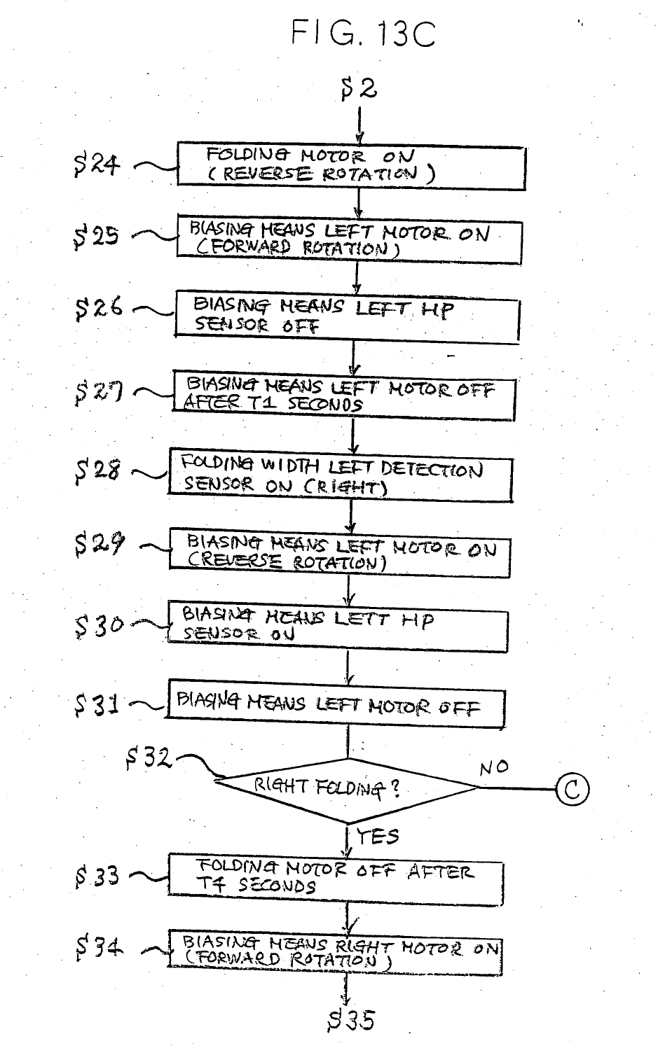

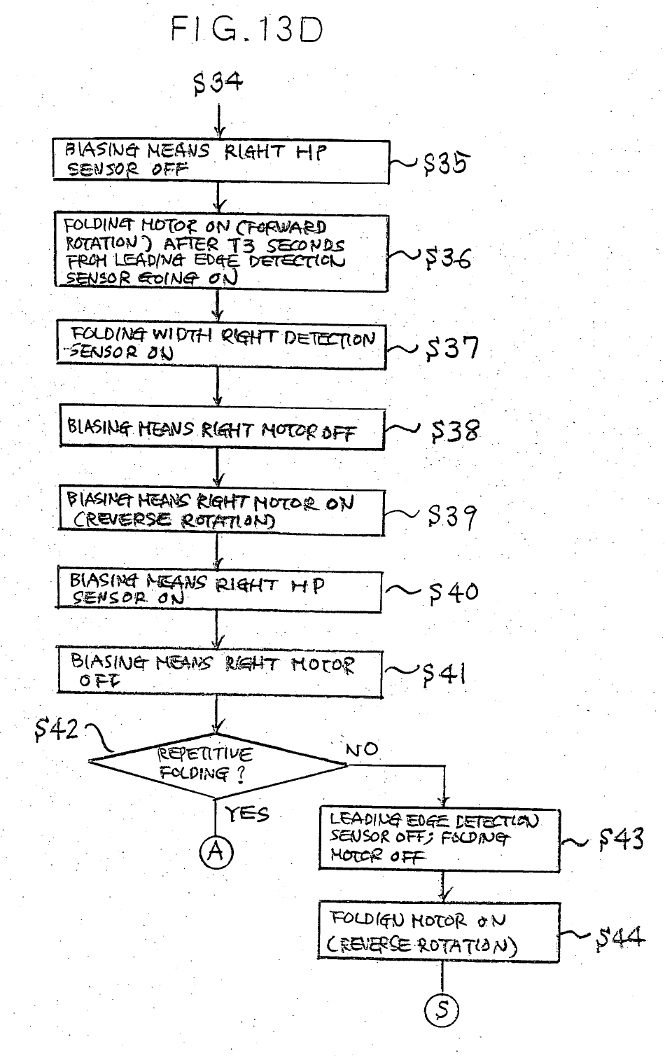

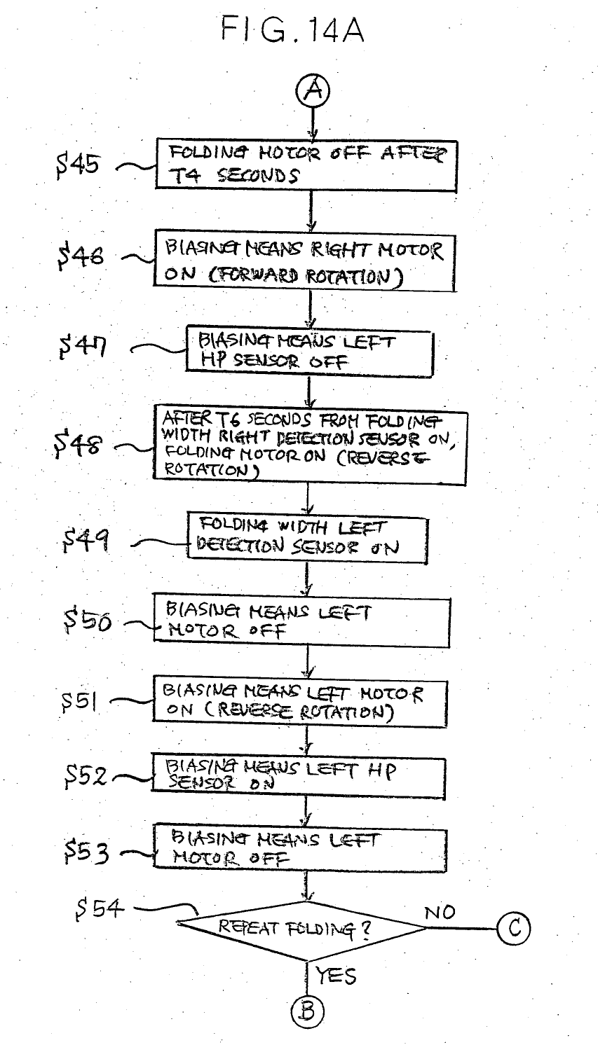

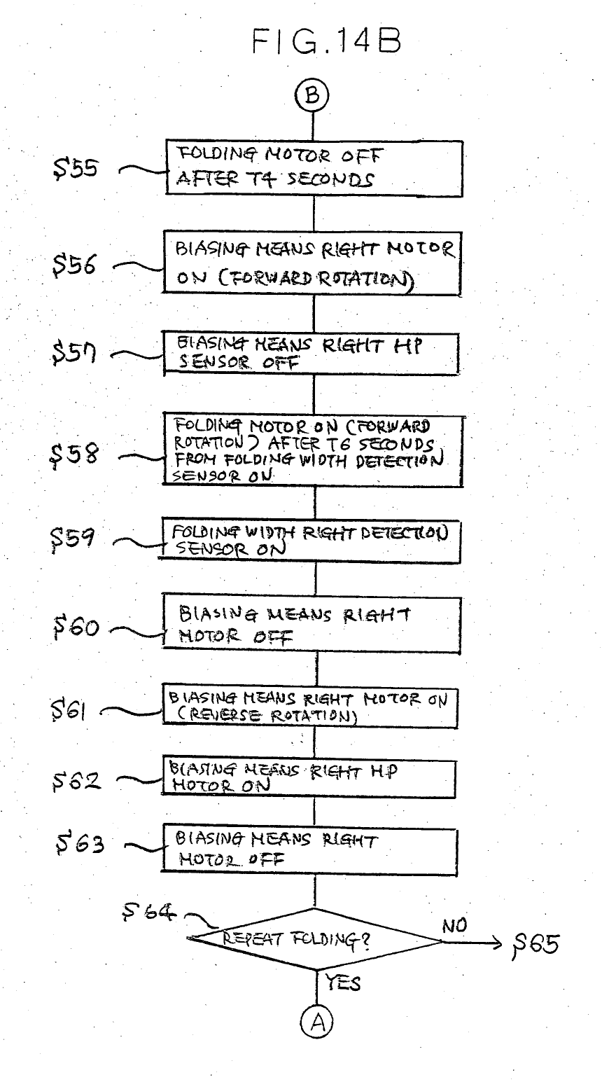

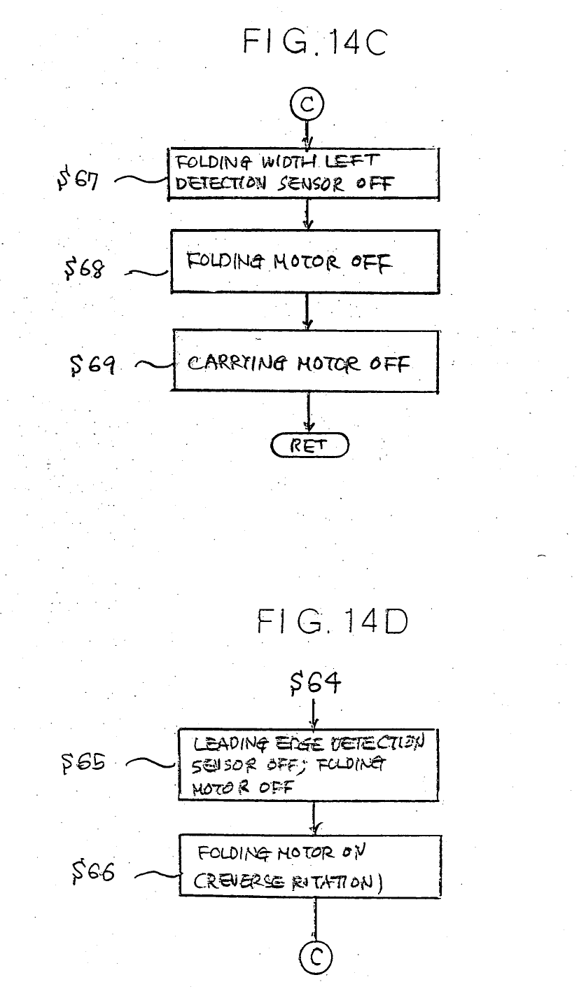

Biasing means 20 and 21 are provided on outer sides of the carry roller pair 14 and switch the guiding of the leading edge of the paper to either the folding roller pair 11 or 12. The biasing means 20 and 21 are each set having a circular arc trajectory so as to contact the lower folding rollers 11b and 12b and made to carry out an advance-retreat movement along the circular arc trajectory by driving gears 22 and 23. The leading edge of the paper is guided by the biasing means 20 and 21 to approach the folding roller pairs 11 and 12 and enter the nips of the folding roller pairs 11 and 12. At this time, whether the leading edge of the paper enters the nip of the folding roller pair 11 or 12 is selected by which of the biasing means 20 and 21 is moved. In the drawing here, the biasing means 20 that guides to the folding roller pair 12 on the right side is the right biasing means and the biasing means 21 that guides to the folding roller pair 11 on the left side is the left biasing means. Further still, as shown in FIG. 6, at the time of folding paper, the biasing means 20 and 21 are structures that guide the inner side of the paper to the nip of either of the folding roller pairs 11 and 12. At this time, rollers 20a and 21a constructed at the leading ends of biasing means 20 and 21 come into contact with the lower folding rollers 11b and 12b respectively. It should be noted that this operation is described separately with reference to the flowcharts of FIGS. 13A to 13E and 14A to 14D.

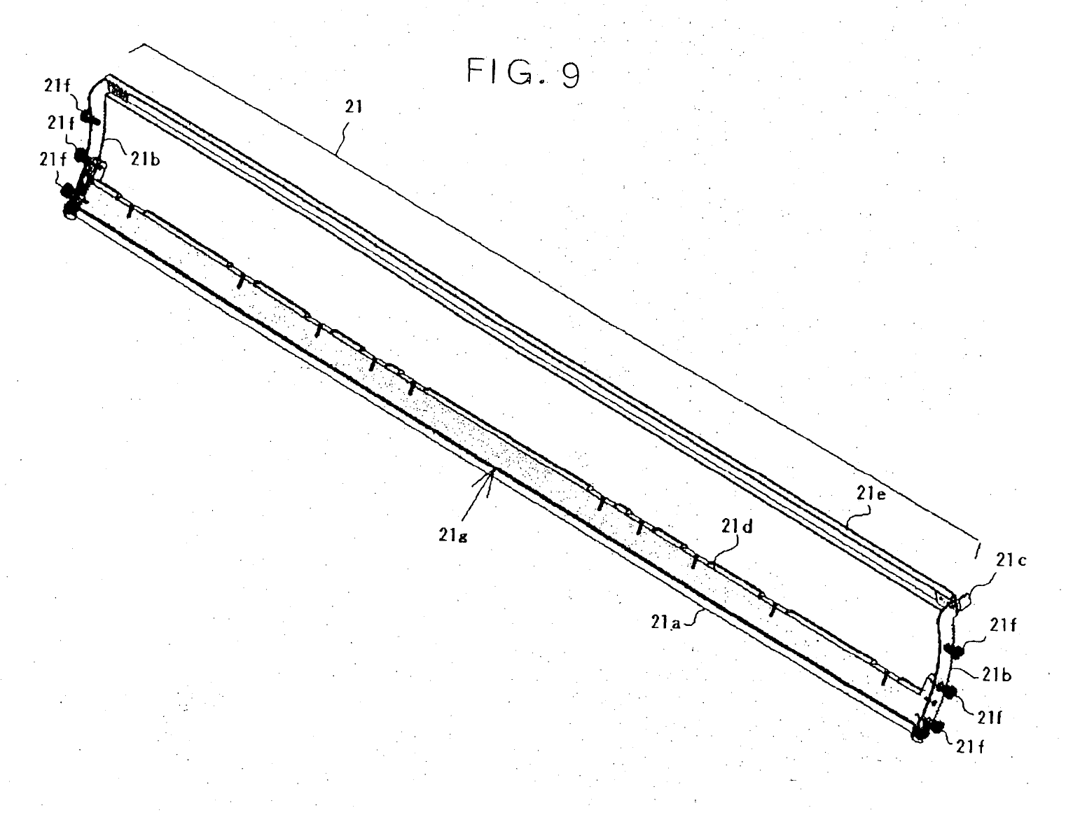

A configuration of the biasing means 20 and 21 is shown in the exploded perspective view of FIG. 9. The biasing means shown in FIG. 9 is the left biasing means 21, but the right biasing means 20 has the same configuration with lateral symmetry. A side plate 21b having a gear portion 21b′ is arranged on both ends of the left biasing means 21, and a guiding plate 21d that guides the leading edge of the paper is provided between the side plates 21b connecting both side plates 21b. Moreover, a stay 21e is also provided between the side plates 21b supporting the side plates 21b. On the stay 21e, a light shielding plate 21c is provided that shields light of the biasing means home position sensor (hereinafter referred to biasing means HP sensor) 24, 25 of FIG. 4. Furthermore, a roller 21a having a width greater than the maximum paper width is provided between the ends of both the side plates 21b, and the roller 21a is provided with a plurality of bearings not just at both side plates but at a leading edge portion 21g of the guiding plate 21d, with the roller 21a being supported such that the rotation and load of the roller 21a is borne and no bending occurs in the roller 21a. Here, the leading edge portion 21g of the guiding plate 21d supports the entire width of the roller 21a, but partial support is also possible. Furthermore, the leading edge portion 21g is coated with Teflon (registered trademark), but it is also possible to use a resin material having a low coefficient of friction for the guiding plate 21d itself. Also, the roller 21a may be a pipe material. It should be noted that the right biasing means 20 similarly has a side plate 20b and a gear portion 20b′ is provided in this side plate.

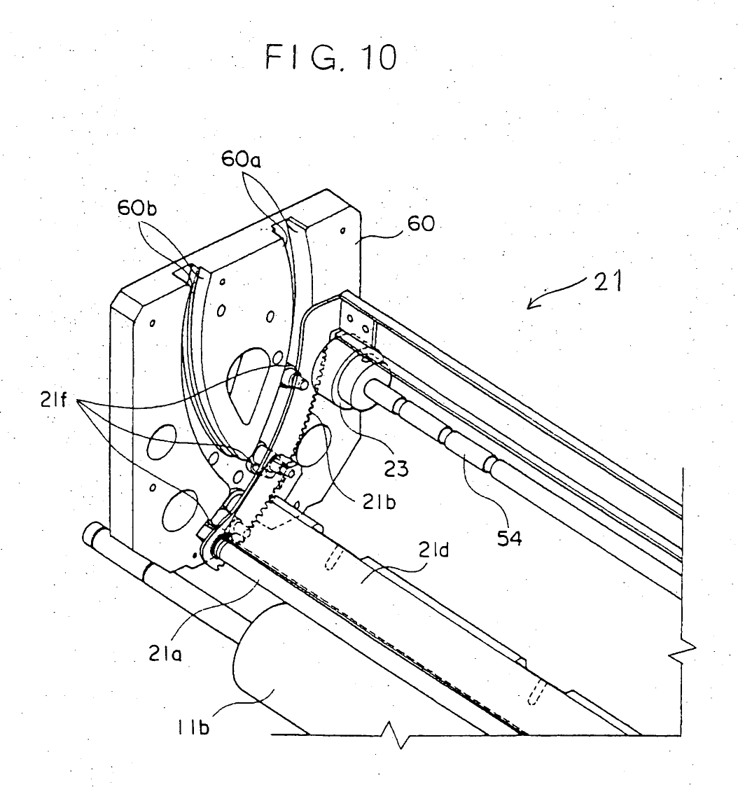

Further still, a plurality of rollers 21f are provided protruding at an outer side of both side plates 21b. As shown in FIG. 10, a pair of rails 60 is provided on both outer sides of the biasing means 20 and 21 and rail grooves 60a and 60b are notched into the rails 60 in a circular arc shape so that the biasing means 20 and 21 come in contact with the respective lower folding rollers 11b and 12b, and rollers 21f are movably provided in the rail grooves 60 such that the biasing means 20 and 21 move up and down along a circular trajectory. That is, the rollers 21f make contact inside the rail grooves 60a and 60b and gear portions 20b′ and 21b′ of the biasing means 20 and 21 mesh with drive gears 22 and 23, and the biasing means 20 and 21 contact the respective rollers 11b and 12b and rotate along a circular trajectory so as to separate due to the rollers 21f rotating inside the rail grooves 60a and 60b.

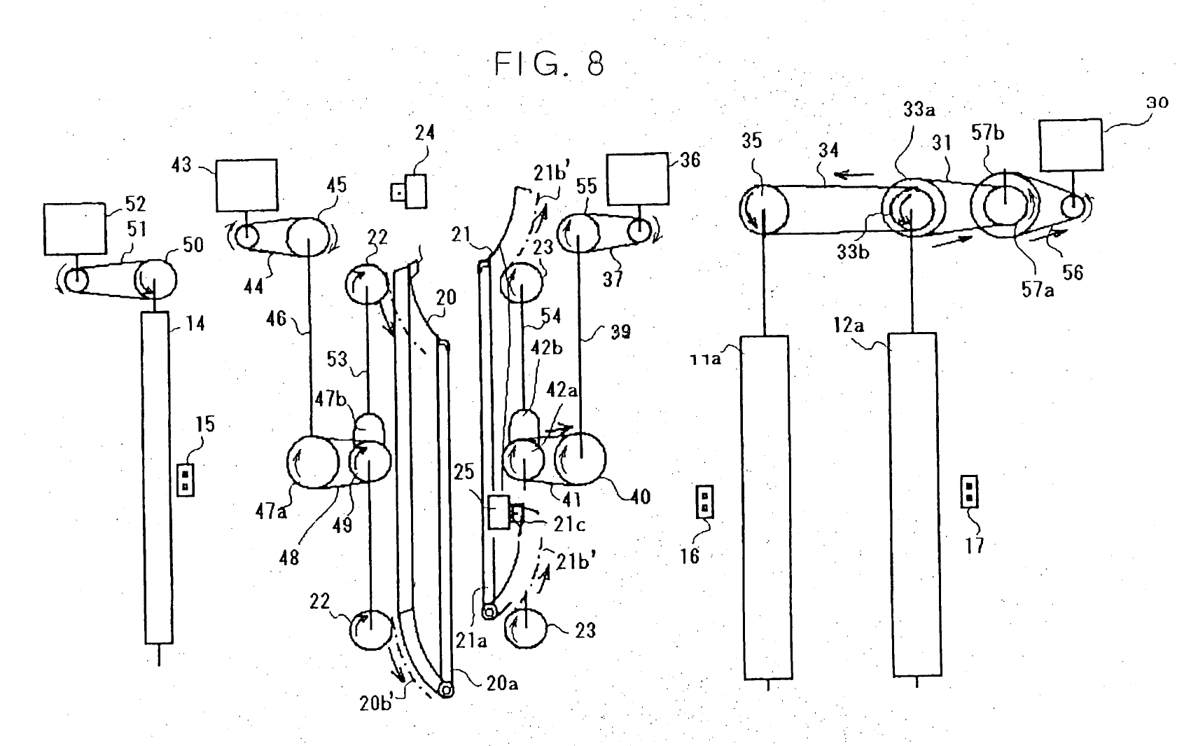

The paper folding device 1 according to the present embodiment is provided with a drive means shown in FIG. 8. With this drive means, drive side rollers of a pair of carry rollers 14 transmit the rotation of a carrying motor 52 via a drive belt 51 by a pulley 50 linked to an end portion and rotates in a carrying direction (the arrow direction shown in FIG. 8). Furthermore, a leading edge detection sensor 15 is provided in a central vicinity of the pair of carry rollers 14.

The drive of the biasing means 20 and 21 has the same configuration in lateral symmetry and therefore the left biasing means 21 is used here for description. First, the drive gear 23 meshes with the gear portions 21b′ at both ends of the left biasing means 21. Both ends of the drive gear 23 are driven fastened onto a same single drive shaft 54, and therefore the left biasing means 21 moves parallel to the same drive shaft 54 by the amount by which the drive shaft 54 rotates. The drive shaft 54 is linked with a driven pulley 42a via a torque limiter 42b, and the driven pulley 42a and the drive pulley 40 are linked and driven by the drive belt 41. Further still, the drive pulley 40 and the drive pulley 55 on a same shaft 39 are linked to a biasing means left motor 36 via the drive belt 37. Accordingly, when the biasing means left motor 36 rotates in the arrow direction, the left biasing means 21 moves in the arrow direction. At that time, if a load greater than the rotation load torque of the torque limiter 42b is applied to the left biasing means 21, sliding occurs while torque is produced between the torque limiter 42b and the driven pulley 42a. Further still, the light shielding plate 21c is arranged at an end portion of the biasing means 21, and the biasing means left HP sensor 25 blocks the light at a position where the biasing means 21 is at standby to rise, and the standby position is detected in this manner. It should be noted that the right biasing means 20 has the same configuration and the rotation direction of when the right biasing means 20 is descending is shown in FIG. 8. However, with the right biasing means 20, the numeral 43 is a biasing means right motor, the numeral 44 is a drive belt, the numeral 45 is a drive pulley, the numeral 46 is a shaft, the numeral 47a is a drive pulley, the numeral 49 is a driven pulley, the numeral 48 is a drive belt, the numeral 47b is a torque limiter, and the numeral 53 is a drive shaft, and the right biasing means 20 is driven in the same manner as the left biasing means 21 via the drive gear 22.

The folding roller pairs 11 and 12 are driven as follows. Namely, a folding roller drive pulley 35 is linked to an end portion of the upper folding roller 11a and a folding roller drive pulley 33b is linked to an end portion of the upper roller 12a, and the folding roller drive pulley 35 and the folding roller drive pulley 33b are linked by a drive belt 34. Further still, a pulley 33a that is integrated with the folding roller drive pulley 33b is linked to a driven pulley 57a via the drive belt 31 and, moreover, a driven pulley 57b that is integrated with the driven pulley 57a is linked with a drive pulley on the folding motor 30 side via the drive belt 56. Accordingly, when the folding motor 30 rotates in the arrow direction of the diagram, the upper folding rollers 11a and 12a rotate in synchronization in the arrow direction. Further still, due to an unshown drive belt linking the upper folding rollers 11a and 12a and the lower folding rollers 11b and 12b, when the folding motor 30 rotates the folding roller pairs 11 and 12 rotate in the carrying direction with the upper and lower folding rollers 11a, 12a, 11b, and 12b in synchronization. Further still, a folding width right sensor 17 and a folding width left sensor 16 are arranged respectively in outer side central vicinities of the folding roller pairs 11 and 12.

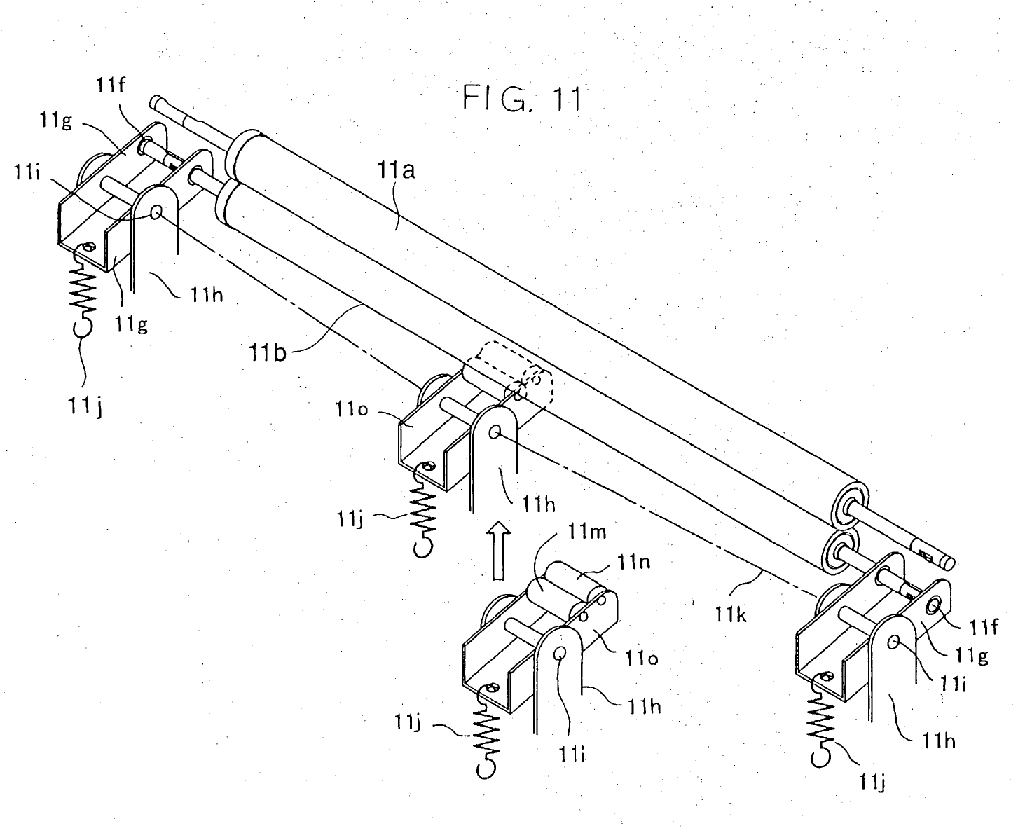

FIG. 11 is a perspective view showing a pressurized structure of a central portion of the folding rollers 11 and 12. As shown in this diagram, with the folding roller pair 11a and 11b, the upper side folding roller 11a is fixed and the lower side folding roller 11b is supported by end levers 11g through bearings 11f at either end. The end levers 11g are oscillatably supported centered on a fulcrum shaft 11i of a pair of support plates 11h and tension springs 11j are latched to end portions positioned on opposite sides from the bearings 11f with respect to the fulcrum shaft 11i such that the end portions of the end levers 11g are elastically biased downward. Due to an effect of the end levers 11g and the tension springs, the lower side folding roller 11b is elastically biased to the upper side folding roller 11a. In this way, the lower side folding roller 11b is subjected to pressure at both end portions with respect to the upper side folding roller 11a.

Applying an elastic bias in this manner is sufficient, but when the folding rollers 11a and 11b are thin, and in particular when the shaft member is thin, it is conceivable that the suppressive force at the central area is insufficient due to flexing. When this is a concern, a central lever 11o, which is constructed on a fulcrum shaft center on a same axis line as a fulcrum shaft center 11k of the support plates 11h and that has a pair of rollers 11m and 11n parallel to the fulcrum shaft center 11k, is provided below a central vicinity of the roller 11b. In this case, the roller 11b is rotatably supported by the pair of rollers 11m and 11n, and the roller 11b applies pressure to a center of the roller 11a due to a spring 11j in the same manner as the end levers 11g. The same property is provided to three springs 11j. In this way, the flexure of the folding roller pair 11a and 11b can be made uniform and the evenness of the nip between these two members can be improved. As a result, occurrences of wrinkling on the paper due to folding can be kept to a minimum.

Furthermore, in FIG. 11, description was given regarding the left side folding roller pair 11a and 11b, but it should be emphasized that the same is true regarding the right side folding roller pair 12a and 12b.

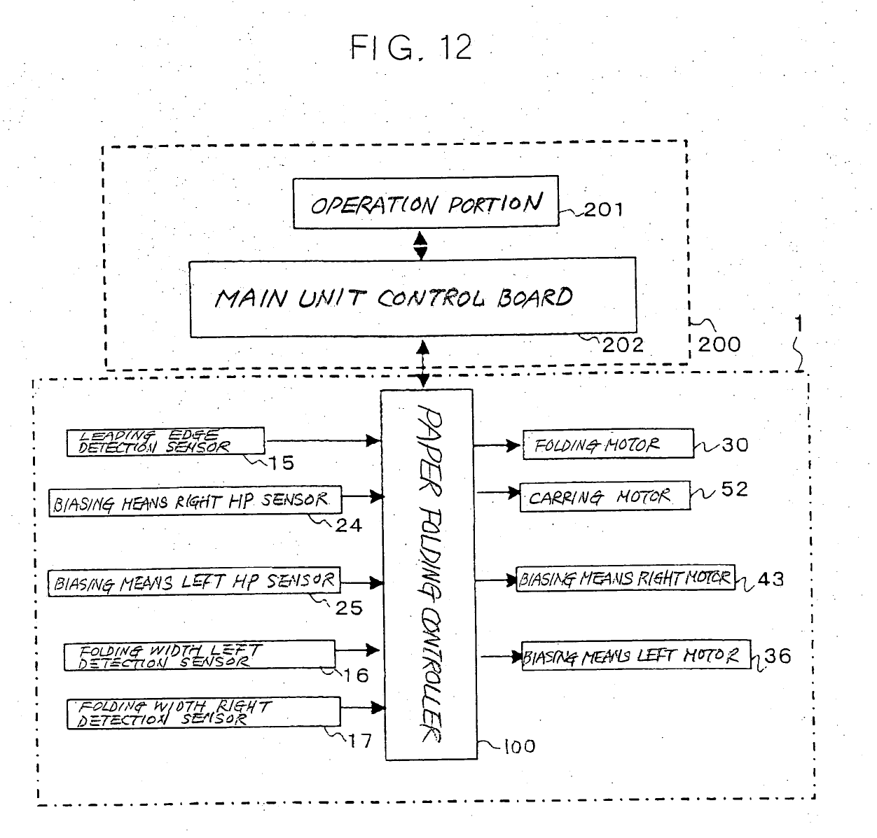

FIG. 12 is a block diagram showing an outline of a control circuit. A control portion of the copying machine main unit 200 is constituted by an operation portion 201 and a main unit control board 202, and the control portion of the paper folding device 1 is constituted by a paper folding controller 100, sensors such as a leading edge detection sensor 15, a biasing means right HP sensor 24, a biasing means left HP sensor 25, a folding width left detection sensor 16, and a folding width right detection sensor 17, and various drive portions such as a folding motor 30, a carrying motor 52, a biasing means right motor 43, and a biasing means left motor 36. The paper folding controller 100 drive controls the motors 30, 52, 43, and 36, and the main unit control board 202 receives input signals such as the folding type and size from operation portion 201 of the main unit, and the paper folding controller 100 controls the folding motor 30, the carrying motor 52, the biasing means right motor 43, and the biasing means left motor 36 based on the information received from the main unit control board and sensor information from sensors such as the leading edge detection sensor 15, a biasing means right HP sensor 24, a biasing means Left HP sensor 25, a folding width left detection sensor 16, and a folding width right detection sensor 17 so that predetermined folding is executed on the paper.

A chain folding operations of the paper folding device is described with reference to the flowcharts of FIGS. 13A to 13D and 14A to 14D. The processes shown in these flowcharts are executed by an unshown CPU of the paper folding controller 100 using an unshown RAM as a work area to run a program stored in an unshown ROM. Detailed description follows.

First, when a signal is inputted from the main unit control portion 201 shown in FIG. 12, the signal is sent to the paper folding controller 100 via the main unit control board 202. In this way, the flowchart of FIGS. 13A to 13D starts at the paper folding device 1 side, the carrying motor 52 of FIG. 8 goes ON, and the carry roller pair 14 of FIG. 4 begins to rotate in the arrow direction (step S0). Next, paper is sent from the copying machine main unit 200, the leading edge of the paper passes the leading edge detection sensor 15, and an ON signal of the leading edge detection sensor 15 is inputted to the controller 100 (step S1). Following this, a determination is made as to whether or not the initial paper carrying according to the paper folding type signal inputted from the main unit control portion 201 of FIG. 12 is a paper folding type in which the paper enters the right side folding rollers 12 (step S2). Description here concerns when the paper folding type signal is a paper folding type in which the initial paper carrying involves entering the right side folding rollers 12. Following this, the folding motor 30 of FIG. 8 turns ON and commences to rotate (here this is forward rotation) (step S3), the biasing means right motor 43 of FIG. 8 turns ON, and right biasing means 20 of FIG. 4 commences to move from the solid line position toward the dashed line position (the rotation direction is forward at this time) (step S4).

At this time, the biasing means right HP sensor 24 goes OFF (step S5) and, after a drive time T1 in which the right biasing means 20 reaches the dashed line position from the solid line position, the biasing means right motor 43 goes OFF (step S6). At this time, as shown in FIG. 4, the roller 20a of the leading edge of the right biasing means 20 and the lower folding roller 12b do not contact and the right biasing means 20 is made to stop in a state with a slight gap therebetween. In this state, the leading edge of the paper P enters the nip of the right side folding roller pair 12 as shown in FIG. 4 and the folding width right detection sensor 17 goes on (step S7). After this, in order to return the right biasing means 20 to the standby position, the biasing means right motor 43 goes ON in the reverse rotation direction (step S8), the biasing means right HP sensor 24 goes ON (step S9), the biasing means right motor 43 goes OFF (step S10), and the right biasing means 20 returns to a standby state at the solid line position.

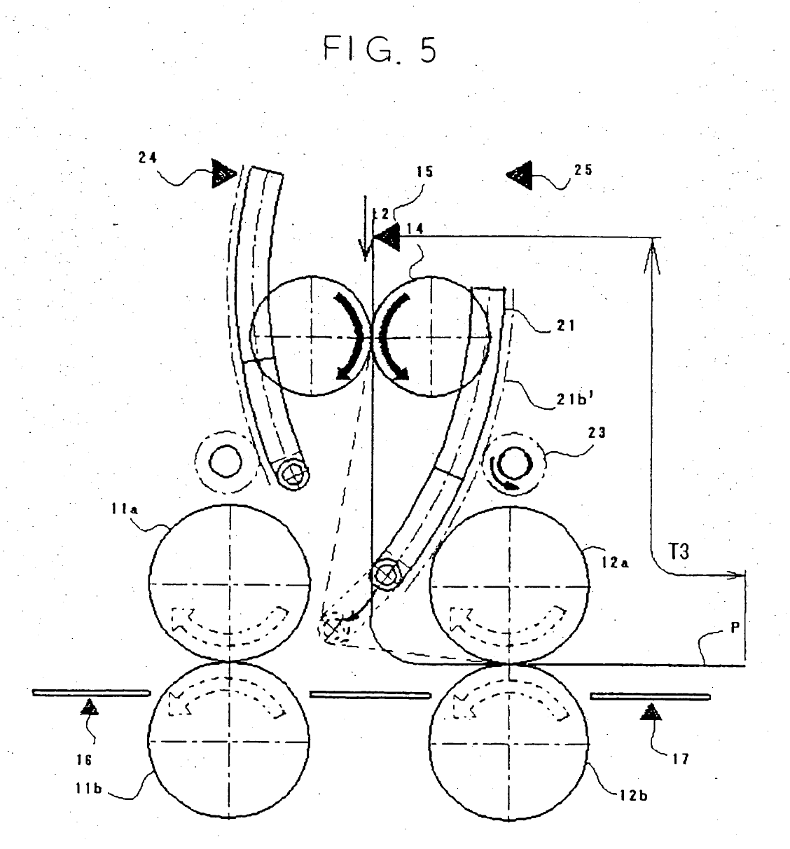

Next, after the leading edge of the paper enters the right side folding roller pair 12, a determination is carried out as to whether or not there is a next folding (step S11), and if there is a next folding, after T4 seconds from the folding width right detection sensor 17 going ON, the folding motor 30 goes OFF and stops (step S12), and this time, in order to guide the inner side of the paper to the nip of the left folding roller pair 11, the biasing means right motor 36 of FIG. 8 goes ON, and the left biasing means 21 of FIG. 5 commences moving in the arrow direction (the rotation direction at this time is forward) (step S13). At this time the biasing means left HP sensor 25 goes OFF (step S14).

At the same time as the operation of the left biasing means 21 and after T3 seconds from the leading edge detection sensor 15 going ON as shown in FIG. 5, the folding motor 30 goes ON in the reverse rotation direction (step S15). At this time, the movement speed of the left biasing means 21 is set faster than the speed at which the paper slackens, and therefore the paper loses slackness as shown by the dashed line in FIG. 5, and the paper and the roller 21a of the leading edge of the left biasing means 21 come in contact. At this time, the movement speed of the left biasing means 21 becomes unable to move faster than the speed at which the paper slackens, and therefore a load is applied to the torque limiter 42b of FIG. 8, and sliding commences while torque is produced between the torque limiter 42b and the drive pulley 42a. Consequently, the roller 21a of the leading edge of the left biasing means 21 apples tension to the paper proportional to the idle torque of the torque limiter 42b, the paper moves while maintaining a tensioned state, and the roller 21a of the leading edge of the left biasing means 21 is brought in contact with the left side lower folding roller 11b as shown in FIG. 6.

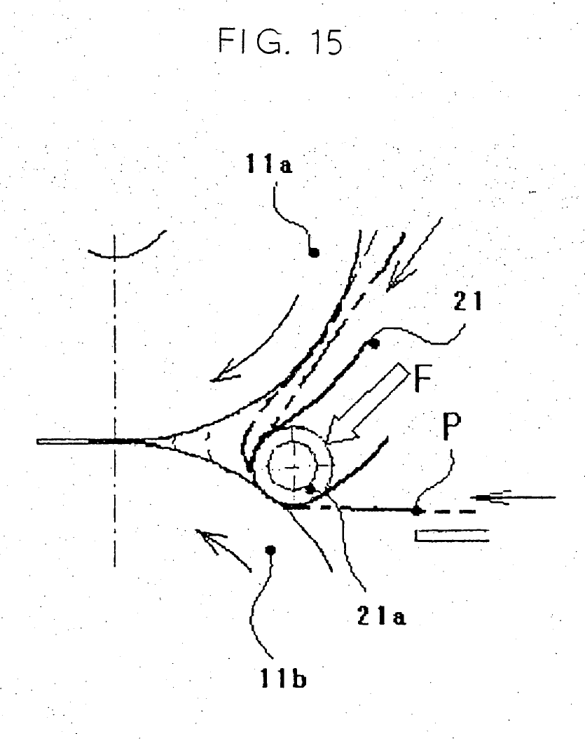

Further still, a pressure F of the idle torque of the torque limiter 42b is applied to the leading edge roller 21a and the lower folding roller 11b as shown in FIG. 15, the paper P is made to further slacken as shown by the dashed line to create a loop, the peak of the loop is gripped in the nip of the left folding roller pair 11 rotating in the arrow direction as shown in FIG. 15, and the paper is folded on the left side. The paper continues to be fed further such that the leading edge of the folded paper reaches the folding width left sensor 16 and the folding width left sensor 16 goes ON (step S16). After this, in order to return the left biasing means 21 to a standby state, the biasing means right motor 36 is stopped (step S17) and then turned ON in the reverse rotation direction (step S18), the biasing means left HP sensor 25 goes ON (step S19) the biasing means left motor 43 goes OFF (S20) to return the left biasing means 21 to the standby state of the solid line position of FIG. 4, thereby completing the first fold.

On the other hand, when there is no fold at the determination of whether or not there is a next fold at step S11, the paper discharge direction is on the left folding roller pair side, and therefore discharge occurs after performing a switchback once, and when the paper trailing edge passes the leading edge detection sensor 15 in a state in which the right folding roller pair 12 carries the paper and the leading edge detection sensor 15 goes OFF, the folding motor 30 stops (step S22), and this time a discharge operation flow C commences in which the folding motor 30 performs reverse rotation (step S23) and the paper trailing edge is carried toward the right folding roller pair 11.

Furthermore, when the determination of whether or not there is a paper folding type in which the initial paper carrying of step S2 involves entering the right side folding rollers 12 is that the paper folding type involves entering the left side folding rollers 11, steps S24 through S42 are carried out in the same manner as steps S3 through S21 with a laterally reverse difference from the case in which the paper enters the right side folding rollers 12. However, when the determination as to whether or not there is a next fold at step S32 is that there is no fold, the paper discharge direction is on the side of the left folding roller pair 11 such that there is no need to perform a switchback before discharging, and therefore the procedure commences the discharge operation flow C at that point.

Here, a determination is carried out as to whether or not there is a repeat fold (steps S21 and S42), and when there is a repeat fold when the first fold is on the left side, a flow B commences involving a right side repeat fold, and when there is no repeat fold, there is no need to perform a switchback before discharging, and therefore the procedure commences the discharge operation flow C at that point.

Furthermore, when there is a repeat fold when the first fold is on the right side, a flow A commences involving a right side repeat fold, and when there is no repeat fold it is necessary to perform a switchback once before discharging, and therefore when the paper trailing edge passes the leading edge detection sensor 15 in a state in which the right folding roller pair 12 carries the paper and the sensor goes OFF, the folding motor 30 goes OFF and stops (step S43), and this time the discharge operation flow C commences in which the folding motor 30 performs reverse rotation (step S44) and the paper trailing edge is carried toward the right folding roller pair 11.

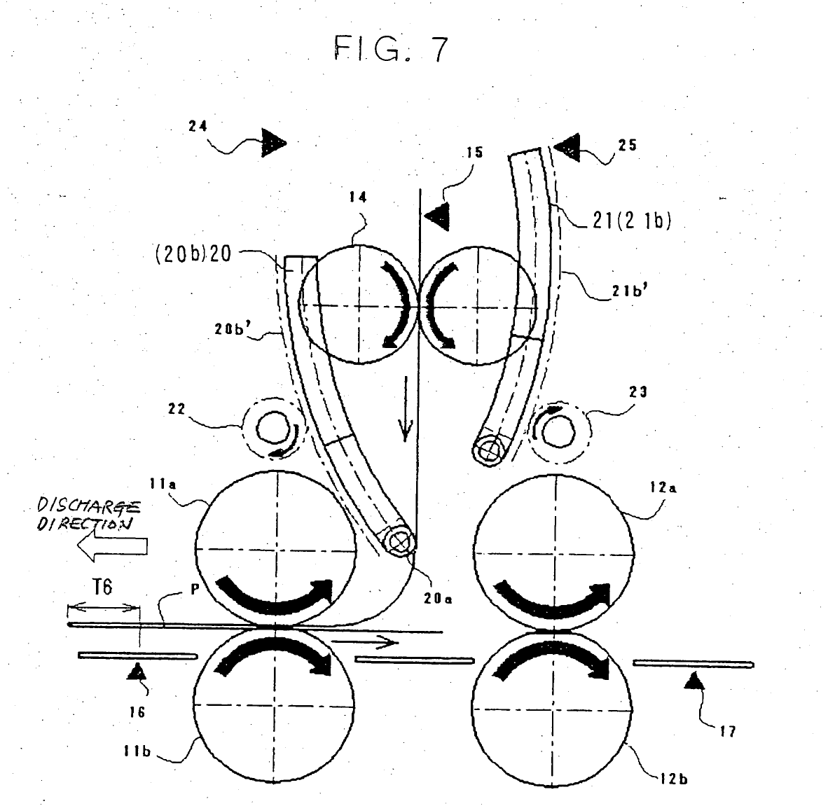

Next, in the case of repeat fold flows A and B, the left fold flow A is almost identical to the first fold steps S12 to S21, and the timing for causing reverse rotation of the folding motor 30 at step S48 in the case of repeat folding is T6 seconds after the folding width right detection sensor 17 goes ON (see FIG. 7). Similarly, the right folding flow B is almost identical to the first fold steps S33 to S42, and the timing for causing forward rotation of the folding motor 30 at step S58 in the case of repeat folding is T6 seconds after the folding width right detection sensor 16 goes ON. After this, when there is further repeat folds, the flows A and B are repeated, and when the final fold is on the right side, the paper discharge direction is on the side of the left folding roller pair, and therefore a switchback is performed once before discharging, and when the paper trailing edge passes the leading edge detection sensor 15 in a state in which the right folding roller pair 12 carries the paper and the leading edge detection sensor 15 goes OFF, the folding motor 30 stops (step S65). Then this time a discharge operation flow C commences in which the folding motor 30 performs reverse rotation (step S66) and the paper trailing edge is carried toward the left folding roller pair 11. When the final fold is on the left side, the procedure commences the discharge operation flow C at that point.

Finally, in the discharge operation flow C, after the paper trailing edge passes the folding width detection sensor 16 and the folding width detection sensor 16 goes OFF (step S67), the folding motor 30 is stopped (step S68), the carrying motor 52 is stopped (step S69) and discharge is completed.

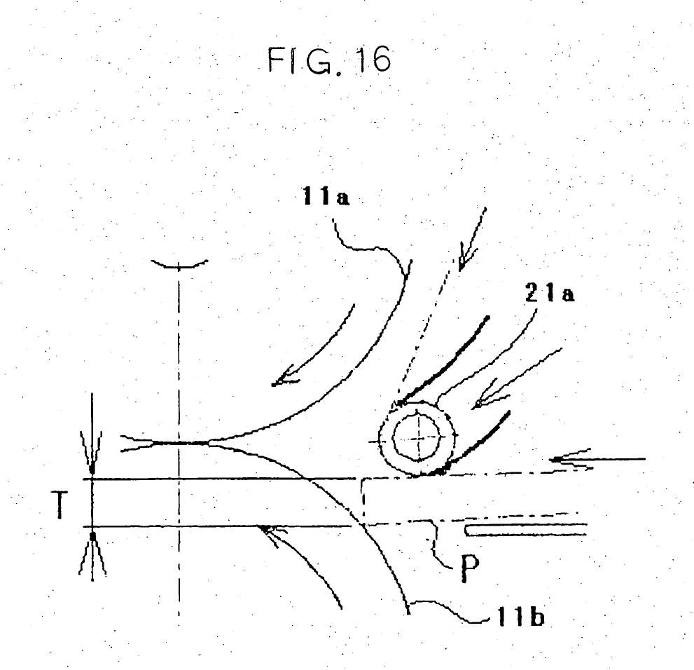

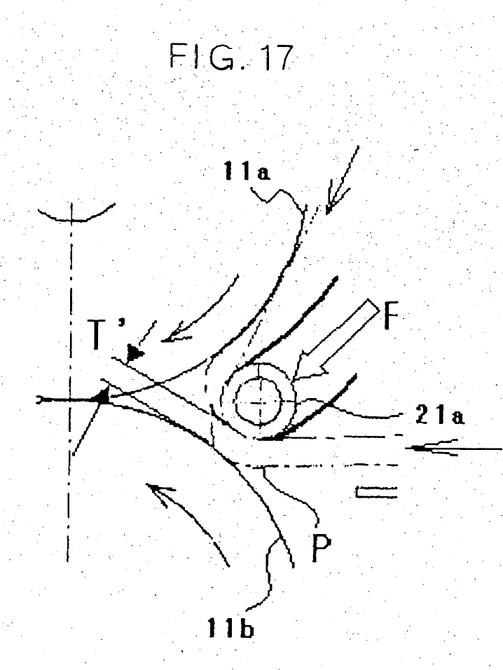

When the paper repetitively undergoes left folding and right folding and piles up, the paper becomes a folded bundle, which is nipped in the folding roller pairs 11 and 12 and carried. In a paper bundle state such as this, the paper forms a loop as shown in FIGS. 16 and 17 (a state where the paper is gripped in the left folding roller pair 11 in this case), and enters the nip of the folding roller pairs 11 and 12. When the paper is repeatedly folded, the paper bundle bulges according to the extent of folding of the folded paper, and a thickness of the paper bundle is shown as T in FIG. 16. When this paper bundle enters the left folding roller pair 11, the paper bundle is brought into contact with the lower folding roller 11b while the leading edge roller 21a of the biasing means 21 applies a pressure F proportional to the idle torque of the torque limiter 42b as shown in FIG. 17, and therefore the bulging of the thickness of the paper bundle is squeezed and becomes a thickness T′ approaching a thickness of the paper itself when stacked. From this state the paper P forms a loop as shown by the dashed line, enters and is gripped at the nip at the left folding roller pair 11 rotating in the arrow direction such that the paper folds on the left side.

In the present embodiment, paper folded repetitively in an accordion shape as shown in FIG. 3 is stacked in the tray 13 by the discharge roller 19, but the same is true when paper folded in an accordion shape is further folded in a cross shape (see the fourth embodiment discussed below) using a folder that folds lengthwise and breadthwise to a particular size and it is possible to use a cross-folding folder mechanism in the present embodiment.

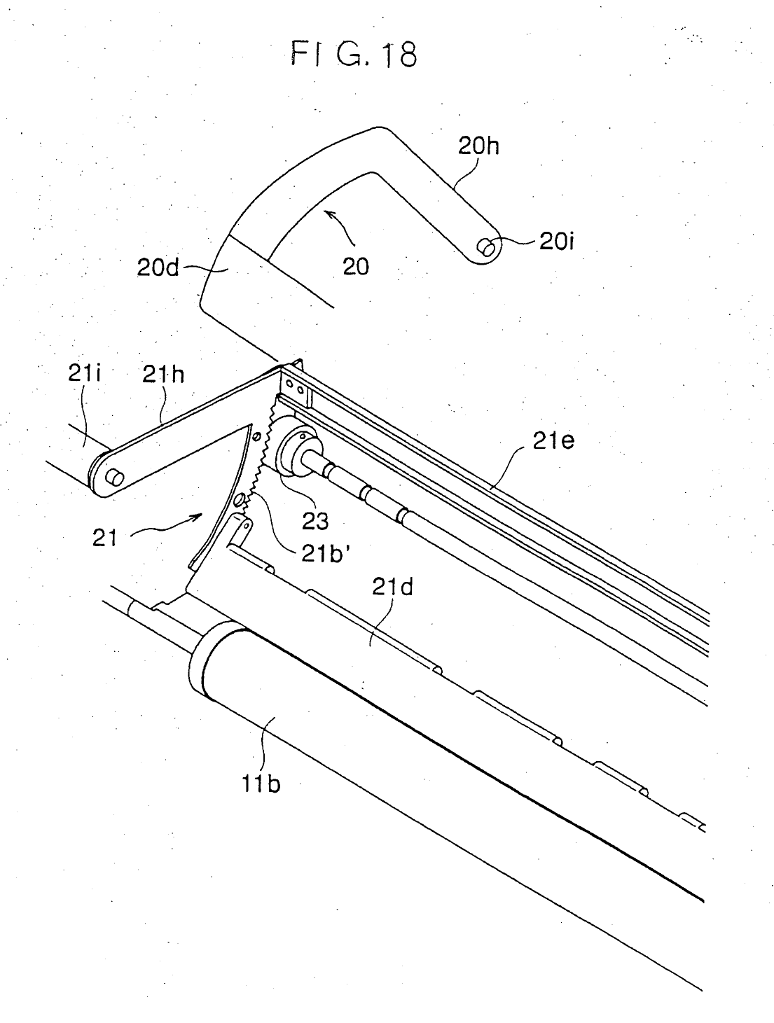

It should be noted that in the present embodiment the rollers 21f move along the pair of rails 60 as shown in FIG. 10 constructed at the outer sides of the biasing means 20 and 21. In this regard, the biasing means 20 and 21 move up and down along a circular arc trajectory so as to contact with the lower folding rollers 11b and 12b respectively. In this case, portions of the grooves where the rail grooves 60a and 60b intersect cannot guide the rollers 21f, and therefore it is conceivable that the carrying speed of the paper may be influenced by the biasing means 20 and 21 not being able to move up and down in a smooth circular arc trajectory. FIG. 18 shows a modification of a drive mechanism of the biasing means shown in FIG. 10. With this modification, biasing means levers 20h and 21h are provided oscillatably supported by rotational fulcrum shafts 20i and 21i such that the biasing means 20 and 21 make contact with the lower folding rollers 11b and 12b respectively as shown in FIG. 18, and the biasing means 20 and 21 are configured so as to move up and down along a circular arc trajectory. At peripheral portions of the circular arc portions of the levers 20h and 21h are formed the drive gears 22 and 23 and gear portions 20b′ and 21b′ that mesh therewith, and the biasing means 20 and 21 move up and down along a circular arc trajectory so as to contact and separate from the respective folding rollers 11b and 12b by a rotational operation of the biasing means levers 20h and 21h centered on the rotational fulcrum shafts 20i and 21i with a driving force obtained from the drive gears 22 and 23. By configuring this in this way, the biasing means levers 20h and 21h perform a rotational (oscillating) movement centered on the rotational fulcrum shafts 20i and 21i, and therefore a smooth movement becomes possible and there is no effect on the carry speed of the paper.

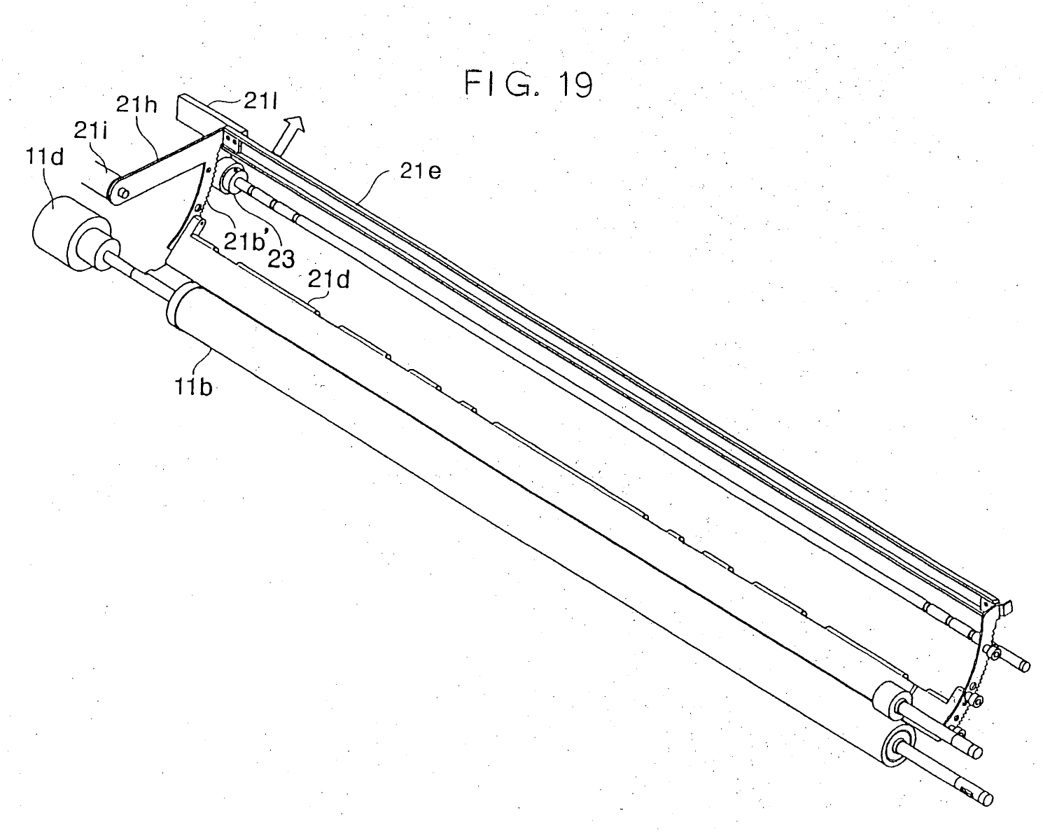

Furthermore, when the levers 20h and 21h are used, jam processing can be carried out easily using the levers 20h and 21h. That is, as shown in FIG. 19, a handle 21l is provided at an end portion of the biasing means 21 (the same for 20) and a jam clearing dial 11d is provided at an end portion of the roller shaft of the lower folding roller 11b. It should be noted that in this embodiment the handle 21l is provided at the lever 21h on the front side of the device or on the stay 21e that connects to both ends of the lever 21h. Furthermore, the jam clearing dial 11d may be provided on the upper folding roller 11a side. When a jam occurs and the biasing means 21 cannot return to the home position, a message is displayed on a display portion of the operation portion 201 and the user is prompted to release the handle 21l in the arrow direction of the diagram.

With this configuration, drive is transmitted by the gear portions 20b′ and 21b′ of the biasing means 20 and 21 meshing with the drive gears 22 and 23, but since the drive gears 22 and 23 transmit drive via the torque limiter, sometimes the biasing means 20 and 21 are caught by jammed paper due to an occurrence of a jam and slippage occurs at the torque limiter and return cannot be achieved even when a driving force is applied to return the biasing means 21 to the home position. In this case, a repair call (breakdown) is carried out, but in order to avoid a repair call, the user may be prompted to use the handle 21 and move the biasing means 20 and 21 in the arrow direction in the drawing to remove the jam. Then, when the user carries out jam processing and the jammed paper is removed, the biasing means 20 and 21 are returned. Thus a repair call is prevented and improved operability can be achieved.

As described above, with the present embodiment, the biasing means 20 and 21 contact the paper at the lower side folding rollers 11b and 12b of the folding roller pairs 11 and 12 on the paper folding side and the paper to be folded is carried and folded, thereby enabling a loop of paper to be formed close to the folding rollers as shown in FIG. 15, and the diameter of the thus-formed loop can be reduced, and therefore the resistance is reduced when the loop enters the folding roller nip, slippage between the paper and the lower side folding rollers is greatly reduced, and accurate folding can be achieved at the targeted positions. Also, even when repeated folding is carried out, bulging of the paper bundle can be reduced greatly as shown in FIGS. 16 and 17, and when the number of times of folding has increased, unevenness in the paper loop formation can be reduced, and accurate folding can be achieved at the targeted positions.

Furthermore, by providing freely rotatable rollers 20a and 21a at leading edges of the biasing means 20 and 21 and having the rollers 20a and 21a make contact with the paper at the lower side folding rollers 11b and 12b of the folding roller pairs 11 and 12, slippage between the paper P and the folding rollers 11b and 12b is eliminated and the carrying precision can be improved.

Furthermore, by arranging freely rotatable rollers at leading edges of the biasing means 20 and 21, the load of when the rollers 20a and 21a come in contact with the folding rollers 11b and 12b is reduced, the feeding precision of the folding rollers 11b and 12b is stabilized, and accurate folding can be achieved at the targeted positions.

Furthermore, when configuring the rollers 20a and 21a from a single roller having a length greater than the paper width of the paper to be folded, the pressure of the paper P when the rollers 20a and 21a and the folding rollers 11b and 12b come in contact can be made uniform in the width direction, and when the loop shaped paper enters the folding roller nip, rippling in the width direction of the paper is eliminated and wrinkling can be prevented.

Furthermore, when the rollers 20a and 21a are made from pipe shaped rollers, the weight of the biasing means 20 and 21 is reduced, the idle torque of the torque limiters 42b and 47b can be reduced, unevenness in the pressure F of the roller 21a such as that shown in FIGS. 15 and 17 is reduced, and accurate folding can be achieved at the targeted positions. Furthermore, since the idle torque of the torque limiters 42b and 47b can be reduced, the drive motor of the biasing means 20 and 21 can be made smaller, thereby enabling reduced costs.

Furthermore, by having the rollers 20a and 21a supported in the width direction by the biasing means, flexure of the rollers 20a and 21a when the rollers 20a and 21a and the folding rollers 11b and 12b come in contact can be prevented, and the pressure on the paper P can be set evenly across the width direction, and when the loop shaped paper enters the folding roller nip, rippling in the width direction of the paper is eliminated and wrinkling can be prevented.

Furthermore, by coating with Teflon (registered trademark) locations where the rollers 20a and 21a are borne, the rotational load of the rollers 20a and 21a when the rollers 20a and 21a contact the folding rollers 11b and 12b is reduced, the feeding precision of the folding rollers 11b and 12b is stabilized, and accurate folding can be achieved at the targeted positions.

Furthermore, by forming the biasing means 20 and 21 using a resin material having a low coefficient of friction, the rotational load of the rollers 20a and 21a when the rollers 20a and 21a contact the folding rollers 11b and 12b is reduced, the feeding precision of the folding rollers 11b and 12b is stabilized, and accurate folding can be achieved at the targeted positions. Moreover, the resistance when the paper leading edge of FIG. 4 is guided to the folding rollers 11b and 12b by the biasing means 20 and 21 is reduced, unevenness in the timing by which the paper leading edge enters the folding rollers 11b and 12b is reduced, and unevenness in the first fold position can be reduced.

Furthermore, by receiving the rollers 20a and 21a at leading edge portions of the guiding plates 21d or at a plurality of shaft bearing members, partial contact of the rollers 20a and 21a and the shaft bearing portion with respect to the curvature of the biasing means 20 and 21 is prevented, warping of the rollers 20a and 21a over time due to uneven wear of the shaft bearing portion is prevented, and accurate folding can be achieved at the targeted positions.

Furthermore, by ensuring that the rollers 20a and 21a do not contact the first or second lower side folding rollers 11b and 12b when the carry roller pair 14 feeds the paper leading edge to the first or second folding roller pairs 11 and 12, the rollers 20a and 21a do not rotate in a reverse direction to the carrying direction when the leading edge of the paper in FIG. 4 is guided to the folding rollers 11b and 12b by the biasing means 20 and 21, and therefore the resistance of the rollers 20a and 21a is reduced, unevenness in the timing by which the paper leading edge enters the folding rollers 11b and 12b is reduced, and unevenness in the first fold position can be reduced.

Furthermore, since the movement trajectory of the biasing means 20 and 21 is a circular arc shape, the biasing means 20 and 21 can make contact close to the nip of the folding rollers, thereby enabling a loop of paper to be formed close to the folding rollers 11 and 12 as shown in FIG. 15, such that the diameter of the thus-formed loop can be reduced. In this way, the resistance is reduced when the loop enters the folding roller nip, slippage between the paper and the lower side folding rollers 11b and 12b is greatly reduced, and accurate folding can be achieved at the targeted positions.

Furthermore, by bringing the biasing means 20 and 21 in contact with the lower side folding rollers 11b and 12b of the folding roller pair on the side where the paper P folds while applying a constant tension to the paper to carry and fold the paper, a loop of paper can be formed close to the folding rollers 11 and 12 as shown in FIG. 15, such that the diameter of the thus-formed loop can be reduced. In this way, the resistance is reduced when the loop enters the folding roller nip, slippage between the paper and the lower side folding rollers is greatly reduced, and accurate folding can be achieved at the targeted positions.

Furthermore, when repeat folding has been performed, bulging of the paper bundle can be reduced as much as possible as shown in FIGS. 16 and 17 and when the number of times of folding increases, unevenness in the paper loop formation is reduced and accurate folding can be achieved at the targeted positions. Moreover, accurate folding can be achieved at the targeted positions by applying a constant tension to the paper to eliminate paper slackness and accurately bringing a targeted position into contact with the lower side folding roller of the folding roller pair.

Furthermore, since the mechanism of the biasing means 20 and 21 applying a constant tension to the paper is the biasing means drive portion and an operational force of the biasing means is always maintained constantly, the roller pressure F in FIGS. 15 and 17 is stable, and accurate folding can be achieved at the targeted positions.

Furthermore, since the movement speed of the biasing means 20 and 21 is greater than the movement speed by which the paper slackens, the leading edge of the biasing means 20 and 21 is brought into contact with the paper P and paper slackness is eliminated by applying a constant tension without carrying out accurate operational timing or positional control of the biasing means 20 and 21 such that the targeted position can be folded accurately and brought into contact with the lower side folding rollers 11b and 12b of the roller pairs. Thus, it is possible to accurately fold the targeted positions and operational timing or positional control of the biasing means 20 and 21 can become unnecessary or simplified.

Further still, there is no gap between biasing means leading edge and the paper prior to operation of the biasing means 20 and 21, and therefore there is no impact-applying contact between the biasing means leading edge and the paper at the time of biasing means operation. In this way, it is possible to achieve accurate folding without applying any damage such as tearing to the paper.

### Second Embodiment

The following is a description of this embodiment. It should be noted in regard to description of the first embodiment that is substantially applied in the present embodiment that duplicate description thereof is omitted and only portions and characteristics of the present embodiment that are different are described below.

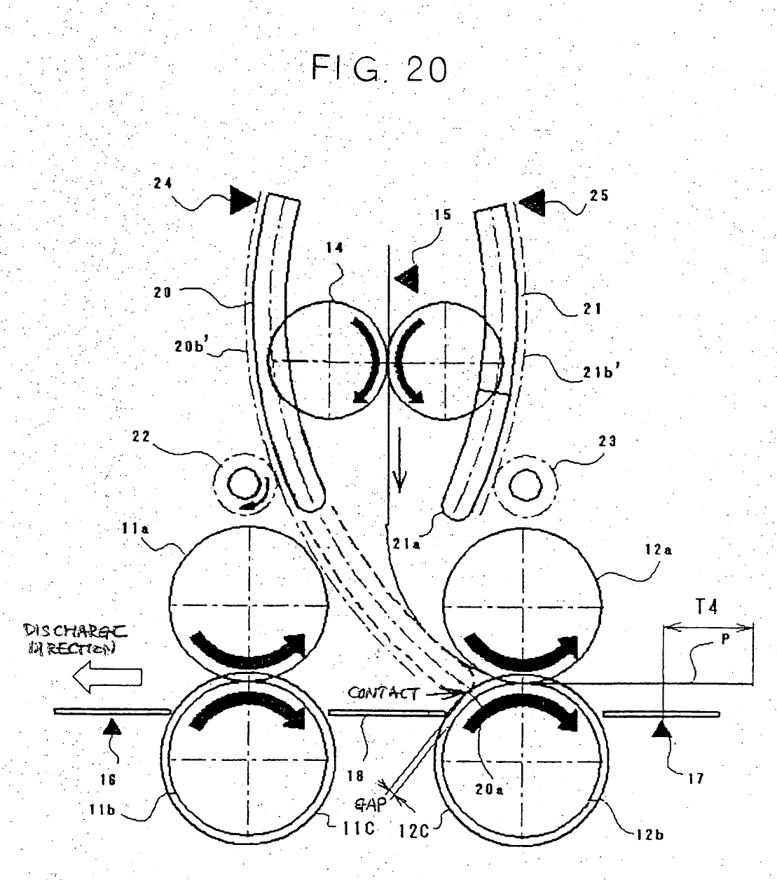

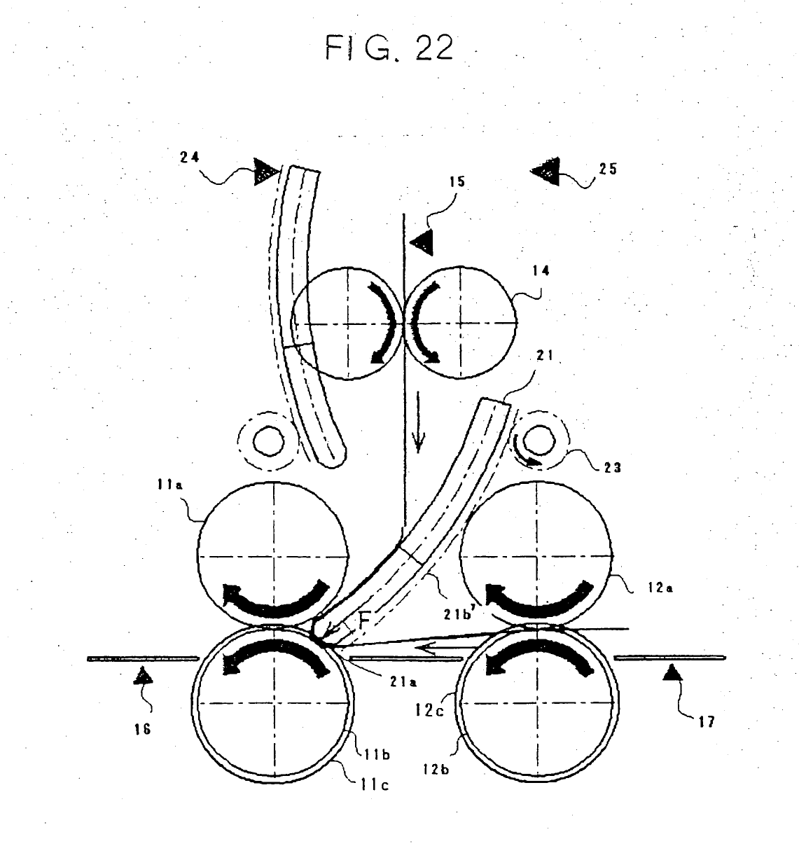

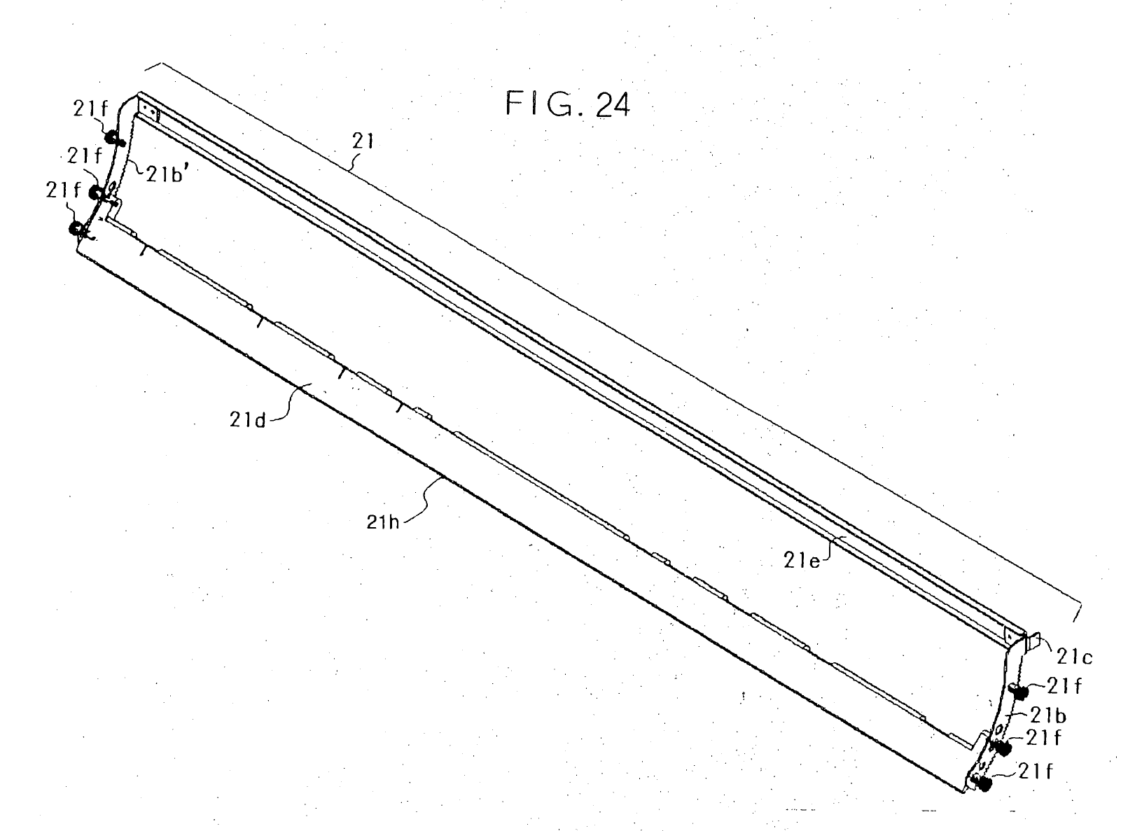

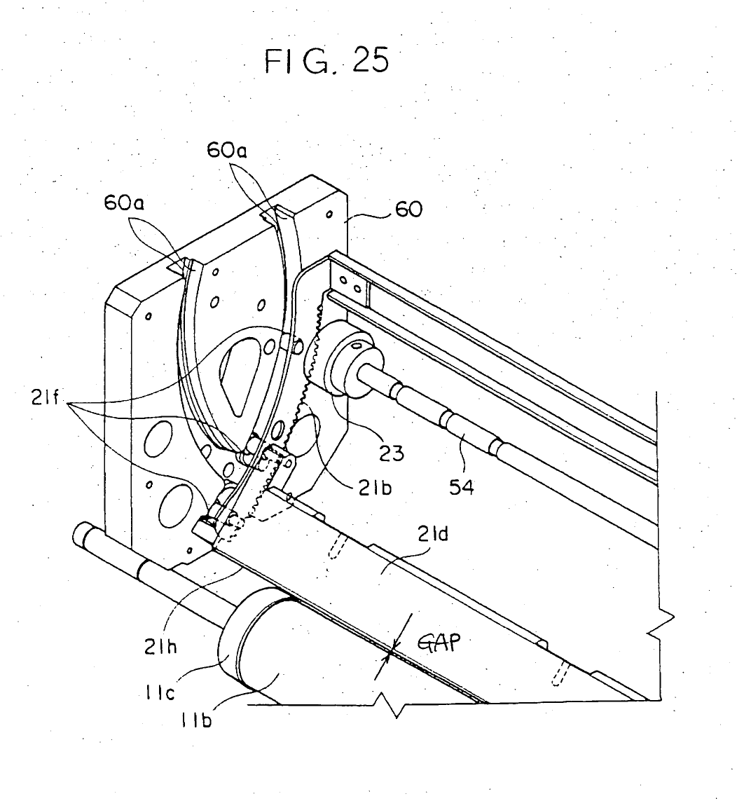

The biasing means 20 and 21 have a circular arc shaped trajectory so as to contact the lower folding rollers 11b and 12b respectively, and the biasing means 20 and 21 are rotationally driven by the drive gears 22 and 23. The leading edge of the paper is guided by the biasing means 20 and 21 to approach the folding roller pairs 11 and 12 and enter the nips of the folding roller pairs 11 and 12. At this time, whether the leading edge of the paper enters the nip of the folding roller pair 11 or 12 is selected by which of the biasing means 20 and 21 is moved. Here, the biasing means 20 that guides to the folding roller pair 12 on the right side is the right biasing means and the biasing means 21 that guides to the folding roller pair 11 on the left side is the left biasing means. Further still, as shown in FIG. 22, the biasing means 20 and 21 are structures that guide the inner side of the paper to the nip of either of the folding roller pairs 11 and 12 at the time of folding paper. At this time, as shown in FIGS. 20, 24, and 25, circular arc shape portions 20h and 21h constructed at the leading ends of biasing means 20 and 21 come into contact with cylindrical collars 11c and 12c constructed on the same shaft as stoppers on the ends of the lower folding rollers 11b and 12b. At this time, the diameter of the collars 11c and 12c is set greater than the diameter of the lower folding rollers 11b and 12b by a thickness of at least one sheet of paper. Consequently, a gap of at least one sheet of paper is made when the circular arc shape portions 20h and 21h come in contact with the respective collars 11c and 12c. Furthermore, in the present embodiment, the material of the lower folding rollers 11b and 12b and the collars 11c and 12c is metal and the lower folding rollers 11b and 12b have undergone urethane coating.

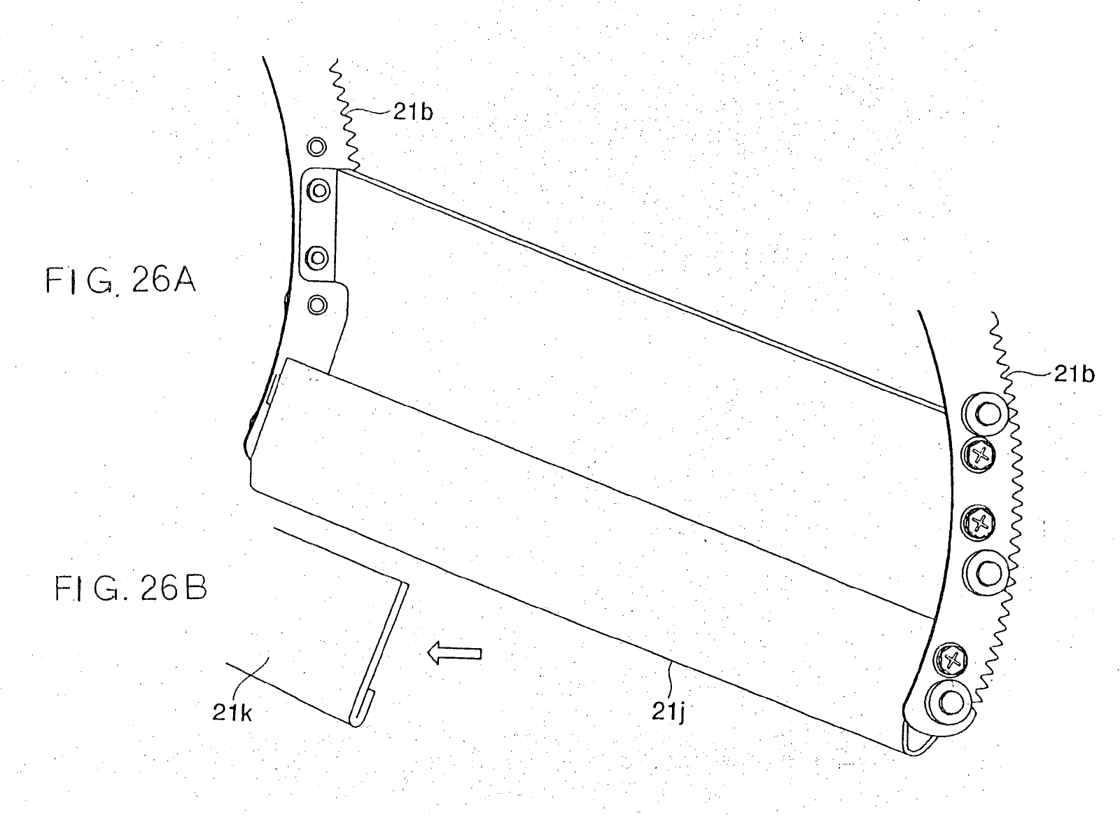

The biasing means 20 and 21 are the same as in the first embodiment in FIG. 9, but the circular arc shape portions 20h and 21h having a width greater than the maximum paper width are provided at the leading edge between the side boards, and the circular arc shape portions 20h and 21h have undergone a fluorine resin coating to be set such that the coefficient of abrasion between the circular arc shape portions 20h and 21h and the paper is lower than the coefficient of abrasion between sheets of paper. That is, in the present embodiment, instead of the rollers 21a in the first embodiment, the metal leading edges are simplified as an “R” shape. In this regard, a sheet metal integrated component shape 21j as shown in FIG. 26A can be used, further still, in order to reduce a diameter R of the leading edge, a component shape 21k can be used in which the leading edge portion is bent over so that the leading edge diameter R is 1 mm in the case of a metal sheet of a sheet thickness of 1 mm for example as shown in FIG. 26B. Reduced costs can be achieved by integrating the leading edge R and the guiding plate 21d in this way using a metal sheet, moreover, by bending over the leading edge portion, the leading edge diameter R can be reduced to the sheet thickness. This enables the paper to be guided very close to the nip of either of the folding roller pair 11 or 12 and makes it possible to reduce folding position unevenness.

The series of paper folding operations of the paper folding device 1 of the present embodiment is similar to the procedure of the flowcharts in FIGS. 13A to 13D and 14A to 14D in the first embodiment, but since the cylindrical collars 11c and 12c are provided in the present embodiment, there are slight differences in the details. Accordingly, description will be given mainly concerning the points of difference.

First, when a signal indicating paper folding is inputted from the main unit operation portion 201 shown in FIG. 12, the signal is sent to the paper folding controller 100 via the main unit control board 202. In this case, the flowchart of FIGS. 13A to 13D starts at the paper folding device 1 side, the carrying motor 52 of FIG. 8 goes ON, and the carry roller pair 14 of FIG. 20 begins to rotate in the arrow direction (step S0). Next, paper is sent from the main unit, the leading edge of the paper passes the leading edge detection sensor 15, and an ON signal of the leading edge detection sensor 15 is inputted to the paper folding controller 100 (step S1). Next, a determination is made as to whether or not the initial paper carrying according to the paper folding type signal inputted from the main unit control portion 201 is a paper folding type in which the paper enters the right side folding rollers 12 (step S2). The folding motor 30 of FIG. 8 turns ON and rotates (here this is forward rotation) in the arrow direction of of FIG. 20 (step S3). Next, the biasing means right motor 43 of FIG. 8 turns ON, and the right biasing means 20 of FIG. 20 commences to move from the solid line position toward the dashed line position (the rotation direction is forward at this time) (step S4).

At this time, the biasing means right HP sensor 24 goes OFF (step S5) and, after a drive time T1 in which the right biasing means 20 reaches the dashed line position from the solid line position, the biasing means right motor 43 goes OFF (step S6). At this time, as shown in FIG. 20, the circular arc shape portion 20h of the leading edge of the right biasing means 20 and the collars 12c at the ends of the lower folding roller 12b come in contact and the right biasing means 20 is caused to stop in a state in which there is a gap greater than the thickness of one sheet of paper. In this state, the leading edge of the paper P enters the nip of the right side folding roller pair 12 as shown in FIG. 20 and the folding width right detection sensor 17 goes on (step S7). After this, in order to return the right biasing means 20 to the standby position, the biasing means right motor 43 goes ON in the reverse rotation direction (step S8), the biasing means right HP sensor 24 goes ON (step S9), the biasing means right motor 43 goes OFF (step S10), and the right biasing means 20 returns to a standby state at the solid line position of FIG. 4.

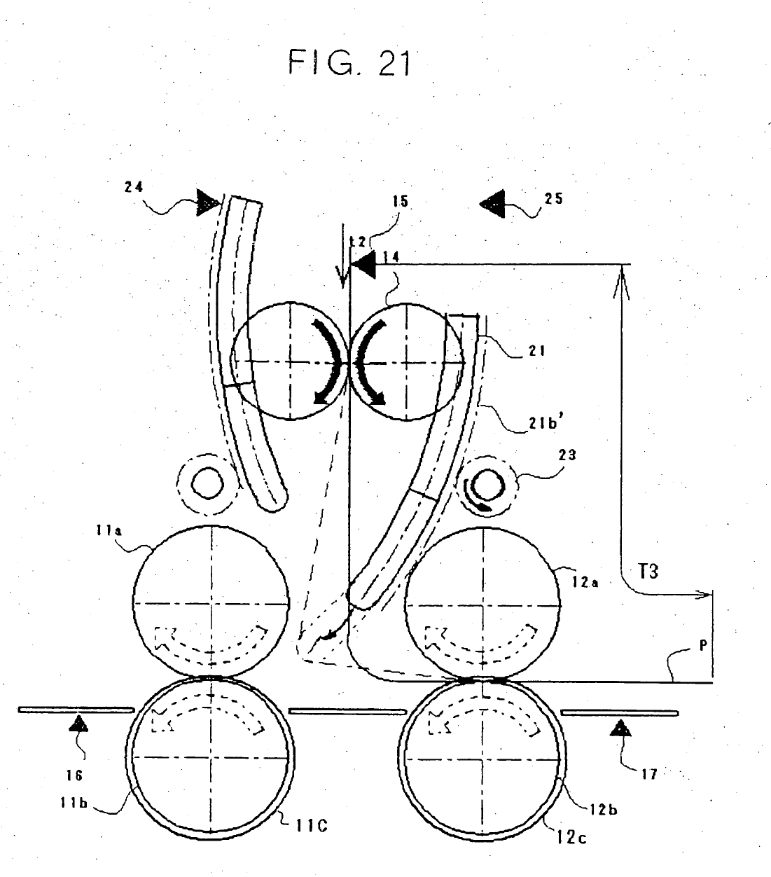

Next, after the leading edge of the paper enters the right side folding roller pair 12, a determination is carried out as to whether or not there is a next folding (step S11), and the following description concerns the case where there is a next folding. After T4 seconds from the folding width right detection sensor 17 going ON, the folding motor 30 goes OFF and stops (step S12), and this time, in order to guide the inner side of the paper to the nip of the left folding roller pair 11, the biasing means right motor 36 of FIG. 8 goes ON, and the left biasing means 21 of FIG. 21 commences moving in the arrow direction (the rotation direction at this time is forward) (step S13). At this time the biasing means left HP sensor 25 goes OFF (step S14).

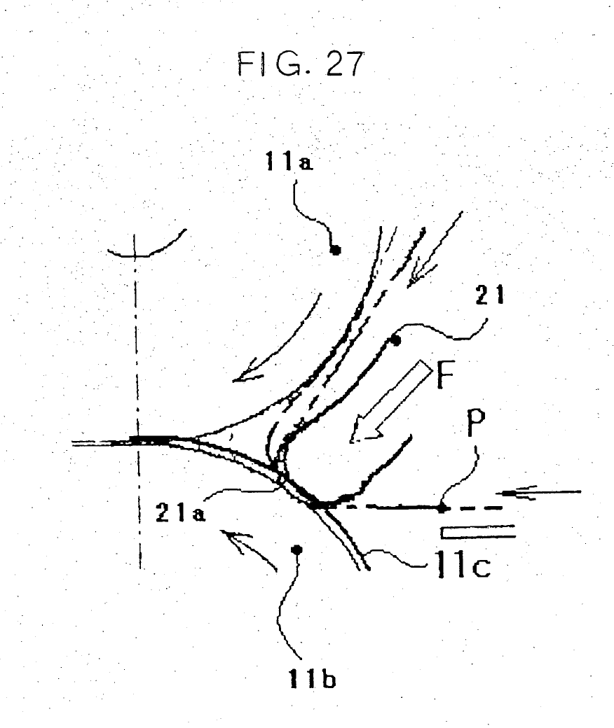

At the same time as the operation of the left biasing means 21 and after T3 seconds from the leading edge detection sensor 15 going ON as shown in FIG. 21, the folding motor 30 goes ON in the reverse rotation direction (step S15). At this time, the movement speed of the left biasing means 21 is set faster than the speed at which the paper slackens, and therefore the paper loses slackness as shown by the dashed line in FIG. 21, and the paper and the circular arc shape portion 20h of the leading edge of the left biasing means 21 come in contact. At this time, the movement speed of the left biasing means 21 cannot become faster than the speed at which the paper slackens, and therefore the left biasing means 21 becomes unable to move at a speed above the speed at which the paper slackens. As a result, a load is applied to the torque limiter 42b of FIG. 8, and sliding commences while torque is produced between the torque limiter 42b and the drive pulley 42a. Consequently, the circular arc shape portion 21h of the leading edge of the left biasing means 21 apples tension to the paper proportional to the idle torque of the torque limiter 42b, the paper moves while maintaining a tensioned state, and the circular arc shape portion 21h of the leading edge of the left biasing means 21 as shown in FIG. 22 is brought in contact with the collars 11c at the ends of the lower folding roller 11b while guiding the paper to the lower folding roller 11b. Further still, as shown in FIG. 27, the paper P further slackens as shown by the dashed line to form a loop, the peak of the loop is gripped in the nip of the left folding roller pair 11 rotating in the arrow direction as shown in FIG. 27, and the paper is folded on the left side. The paper P continues to be fed further such that the leading edge of the folded paper P reaches the folding width left sensor 16, which then goes ON (step S16). After this, in order to return the left biasing means 21 to a standby state, the biasing means right motor 36 is stopped (step S17) and then turned ON in the reverse rotation direction (step S18), the biasing means left HP sensor 25 goes ON (step S9), the biasing means left motor 43 goes OFF (S20) to return the left biasing means 21 to the standby state of the solid line position of FIG. 20, thereby completing the first fold.

If there is no fold at the determination of whether or not there is a next fold at step S11, the paper discharge direction is on the left folding roller pair side, and therefore discharge occurs after performing a switch back once, and when the paper trailing edge passes the leading edge detection sensor 15 in a state in which the right folding roller pair 12 carries the paper and the leading edge detection sensor 15 goes OFF, the folding motor 30 goes OFF and stops (step S22), and this time a discharge operation flow C commences in which the folding motor 30 performs reverse rotation (step S23) and the paper trailing edge is carried toward the right folding roller pair 11.

Furthermore, when the determination of whether or not there is a paper folding type in which the initial paper carrying of step S2 involves entering the right side folding rollers 12 is that the paper folding type involves entering the left side folding rollers 11, steps S24 through S42 are carried out in the same manner as when the paper enters the right side folding rollers 12 with a laterally reverse difference. However, when the determination as to whether or not there is a next fold at step S32 is that there is no fold, the paper discharge direction is on the side of the left folding roller pair 11 such that there is no need to perform a switchback before discharging, and therefore the procedure commences the discharge operation flow C at that point.

Here, a determination is carried out as to whether or not there is repeat folding (steps S21 and S42), and when there is repeat folding when the first fold is on the left side, a flow B commences involving a right side repeat fold, and when there is no repeat fold, there is no need to perform a switchback before discharging, and therefore the procedure commences the discharge operation flow C at that point.

Furthermore, when there is a repeat fold when the first fold is on the right side, a flow A commences involving a right side repeat fold, and when there is no repeat fold it is necessary to perform a switchback once before discharging, and therefore when the paper trailing edge passes the leading edge detection sensor 15 in a state in which the right folding roller pair 12 carries the paper and the sensor goes OFF, the folding motor 30 goes OFF and stops (step S43), and this time the discharge operation flow C commences in which the folding motor 30 performs reverse rotation (step S44) and the paper trailing edge is carried toward the right folding roller pair 11.

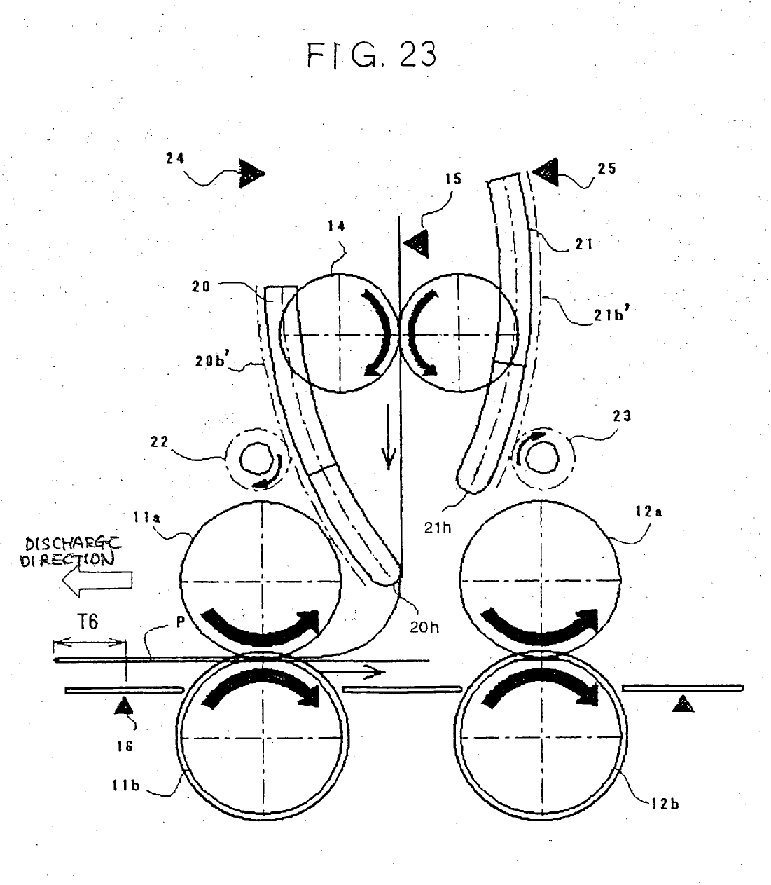

In the case of repeat fold flows A and B, the left fold flow A is almost identical to the first fold steps S12 to S21, and the timing for causing reverse rotation of the folding motor 30 at step S48 in the case of repeat folding is T6 seconds after the folding width right detection sensor 17 goes ON. Similarly, the right folding flow B is almost identical to the first fold steps S33 to S42, and when the timing for causing forward rotation of the folding motor 30 at step S58 is repeated, reverse rotation is caused T6 seconds after the folding width right detection sensor 16 goes ON (see FIG. 23). After this, when there is further repeat folds, the flows A and B are repeated, and when the final fold is on the right side, the paper discharge direction is on the side of the left folding roller pair, and therefore a switchback is performed once before discharging, and when the paper trailing edge passes the leading edge detection sensor 15 in a state in which the right folding roller pair 12 carries the paper and the leading edge detection sensor 15 goes OFF, the folding motor 30 goes OFF and stops (step S65). Then this time a discharge operation flow C commences in which the folding motor 30 performs reverse rotation (step S66) and the paper trailing edge is carried toward the left folding roller pair 11. When the final fold is on the left side, the procedure commences the discharge operation flow C at that point.

Finally, in the discharge operation flow C, after the paper trailing edge passes the folding width detection sensor 16 and the folding width detection sensor 16 goes OFF (step S67), the folding motor 30 is stopped (step S68), the carrying motor 52 is stopped (step S69) and discharge is completed.

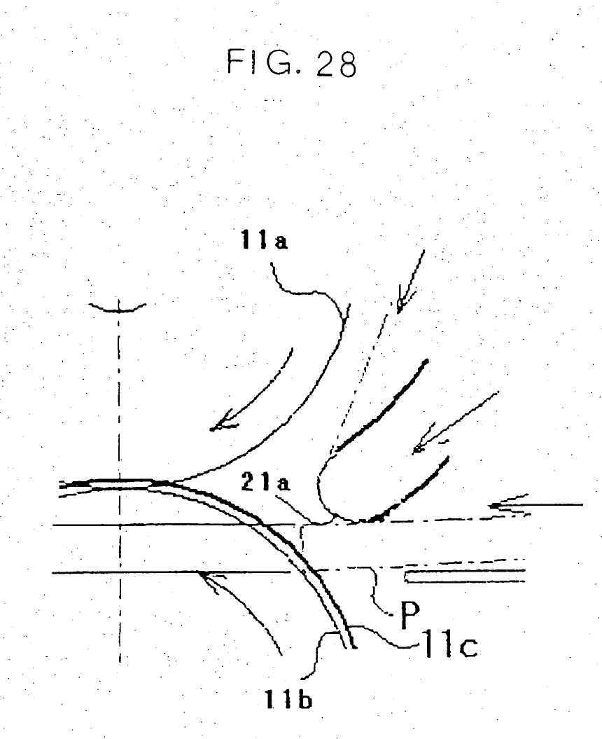

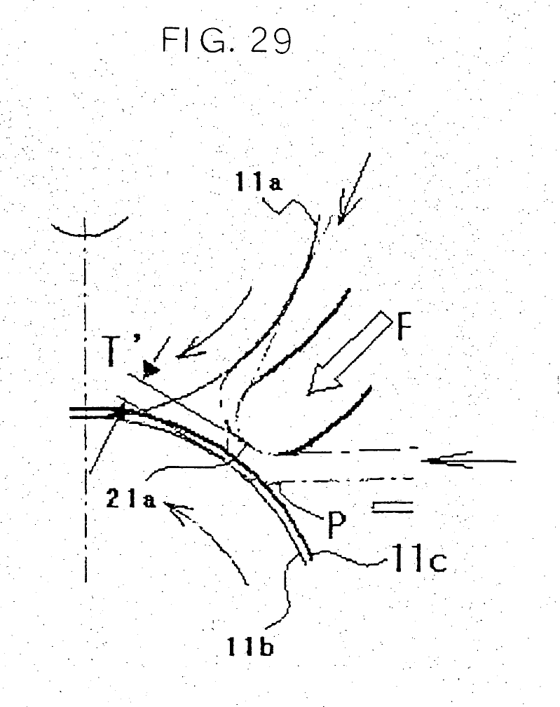

When the paper repetitively undergoes left folding and right folding and piles up, the paper becomes a folded bundle, which is nipped in the folding roller pairs 11 and 12 and carried. In a paper bundle state such as this, the paper forms a loop as shown in FIGS. 27 and 28 (when the paper is gripped in the left folding roller pair 11 in the case of this diagram), and enters the nip of the folding roller pairs 11 and 12. When the paper is repeatedly folded, the paper bundle bulges according to the extent of folding of the folded paper, and a thickness of the paper bundle is shown as T in FIG. 28. A thickness T of the paper bundle has a thickness greater than two sheets of paper due to folding, and therefore there is no contact between the circular arc shape portions 20h and 21h and the collars 11c and 12c at the ends of the lower folding rollers 11b and 12b. Consequently, when the paper bundle enters the left folding roller pair 11, the paper bundle is brought into contact with the lower folding roller 11b while the leading edge circular arc shape portion 21h of the biasing means 21 applies a pressure F proportional to the idle torque of the torque limiter 42 as shown in FIG. 29, and therefore the bulging of the thickness of the paper bundle is squeezed and becomes a thickness T′ approaching a thickness of the paper itself when stacked. From this state the paper P forms a loop as shown by the dashed line, enters and is gripped at the nip at the left folding roller pair 11 rotating in the arrow direction such that the paper folds on the left side.

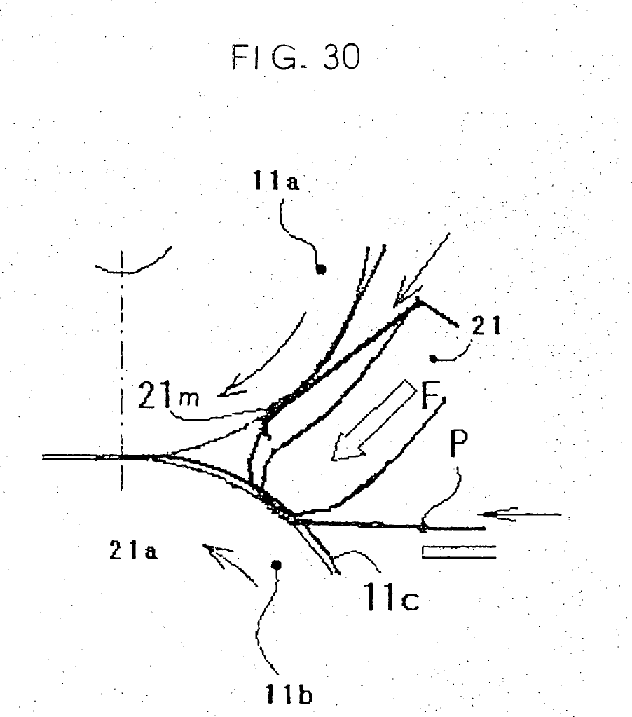

Next, a modification of the second embodiment is described. In this modification, a plate spring 21m as shown in FIG. 30 (FIG. 30 shows a state of gripping with left folding roller pair 11, and therefore a plate spring 20m on the right folding roller pair 12 side is not shown) is provided at the biasing means 20 and 21 of the second embodiment. Further still, when the circular arc shape portions 20h and 21h respectively contact the collars 11c and 12c on the ends of the lower folding rollers 11b and 12b or the paper, the plate springs 20m and 21m are configured so that the paper contacts the upper side folding rollers 11a and 12a of the folding roller pairs 11 and 12 respectively. Other portions are the same as the present second embodiment.

It should be noted that in the present embodiment, paper folded repetitively in an accordion shape as shown in FIG. 3 is stacked in the tray 13 by the discharge roller 19, but the same is true when paper folded in an accordion shape is further folded in a cross shape using a folder that folds lengthwise and breadthwise to a particular size and it is possible to use a cross-folding folder mechanism in the present embodiment.

Other portions not particular described are similarly structured and function similarly as the first embodiment.

With the present embodiment, since the biasing means 20 and 21 have a gap of at least one sheet of paper with respect to the lower side folding rollers 11b and 12b of the folding roller pairs 11 and 12 on the paper folding side, the paper to be folded is supported, and the biasing means 20 and 21 contacts the paper P at the lower side folding rollers 11b and 12b of the folding roller pairs when the number of times of folding increases to guide the paper to the folding roller pairs 11 and 12, a loop of the paper P can be formed close to the folding rollers as shown in FIG. 27, such that the diameter of the thus-formed loop can be reduced, and therefore the resistance is reduced when the loop enters the folding roller nip, slippage between the paper P and the folding rollers 11b and 12b is greatly reduced, and accurate folding can be achieved at the targeted positions. Furthermore, even when repeated folding is carried out, bulging of the paper bundle can be reduced greatly as shown in FIGS. 28 and 29, and when the number of times of folding has increased, unevenness in the paper loop formation can be reduced, and accurate folding can be achieved at the targeted positions.

Furthermore, stoppers (cylindrical collars 11c and 12c) are provided for creating a gap of at least one sheet of paper between the biasing means 20 and 21 and the lower side folding rollers 11b and 12b of the folding roller pairs 11 and 12, and therefore the stoppers and the biasing means come in contact as shown in FIG. 27 when the paper has a thickness of one sheet such that there is no direct contact between the folding rollers 11 and 12 and the biasing means 20 and 21, and the machine does not suffer damage by the biasing means 20 and 21 making contact with folding rollers 11 and 12 with the biasing means 20 and 21 displacing the folding rollers 11 and 12. Thus, a stable paper folding device can be provided.

Furthermore, for a single folding of paper as shown in FIGS. 28 and 29, since the gap between the stoppers and the biasing means is at least one sheet of paper, bulging of the paper bundle that makes contact can be kept as small as possible, and when the number of times of folding has increased, unevenness in the paper loop formation can be reduced, and accurate folding can be achieved at the targeted positions.

Furthermore, since the leading edge of the biasing means 20 and 21 is given a fixed circular arc shape, a paper loop can be formed close to the folding rollers as shown in FIG. 27 and accurate folding can be achieved at the targeted positions. Furthermore, in terms of strength, the strength of the entire biasing means comes in contact with the lower side folding rollers, and therefore warping of the biasing means can be reduced and it is possible to bring the lower side folding rollers into contact with the paper with a uniform pressure, thereby enabling prevention of wrinkling.

Furthermore, by setting the coefficient of abrasion of the circular arc shape surface of the leading edge of the biasing means 20 and 21 lower than the coefficient of abrasion between sheets of paper, when the paper bundle is brought into contact with the lower side folding rollers 11b and 12b by the biasing means 20 and 21 with multiple folding as shown in FIG. 29, there is slippage between the paper and the biasing means rather than slippage between sheets in the paper bundle, and therefore paper bundle misalignment is prevented and accurate folding can be achieved at the targeted positions.

Furthermore, by providing a fluorine resin coating for the circular arc shape surface of the leading edge of the biasing means 20 and 21, the coefficient of abrasion of the circular arc shape surface can be further reduced and accurate folding can be achieved at the targeted positions. In this regard, costs can be reduced by integrating the leading edge R and the guiding plate 21d using sheet metal, and the leading edge diameter R can be reduced to the thickness of the sheet by bending back the leading edge portion. In this way it is possible to bring the paper very close to the nip of either of the folding roller pair 11 and 12 and unevenness in the folding positions can be reduced.

Furthermore, since the first and second folding rollers 11 and 12 and the collars 11c and 12c are made from the same material or the same type of material, even if the rollers 11 and 12 and the collars 11c and 12c expand or contract due to temperature fluctuation in the operating environment, the amount of change is the same, and therefore the gap of at least one sheet of paper does not change and a stable paper folding device can be provided without the machine suffering damage.

Furthermore, since the first and second folding rollers 11 and 12 are metal rollers coated in urethane and the collars 11c and 12c are metal rollers, the coefficient of abrasion of the folding rollers 11 and 12 can be maintained and accurate folding can be achieved at the targeted positions, and also since the gap of at least one sheet of paper does not change, and a stable paper folding device can be provided without the machine suffering damage.

Furthermore, since the pressure applying means is provided at the biasing means 20 and 21 where the upper side folding rollers 11a and 12a of the first or second folding rollers 11 and 12 contacts the paper, a carrying force of the paper and the upper side folding rollers 11a and 12a can be secured, which enables slippage to be prevented. Thus, accurate folding can be achieved at the targeted positions.

Furthermore, since the pressure applying means that brings into contact the upper side folding rollers 11a and 12a of the first or second folding rollers 11 and 12 and the paper is the plate spring 20m, a guiding function is achieved at the time of entrance of the leading edge of the paper and a carrying force of the paper and the upper side folding rollers can be secured, and therefore a stable carrying performance can be achieved.

### Third Embodiment

The following is a description of this embodiment. It should be noted in regard to description of the aforementioned embodiments being substantially applied in the present embodiment that duplicate description thereof is omitted and only portions and characteristics of the present embodiment that are different are described below.

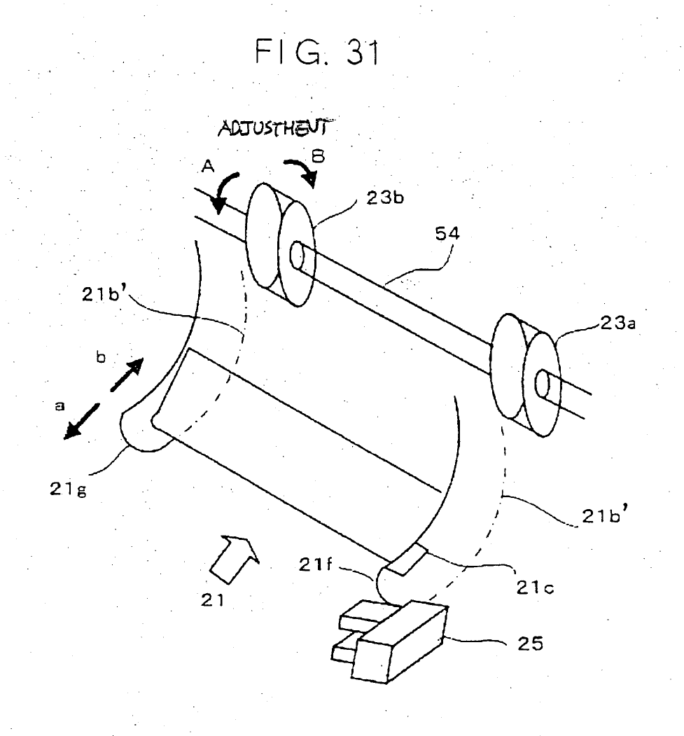

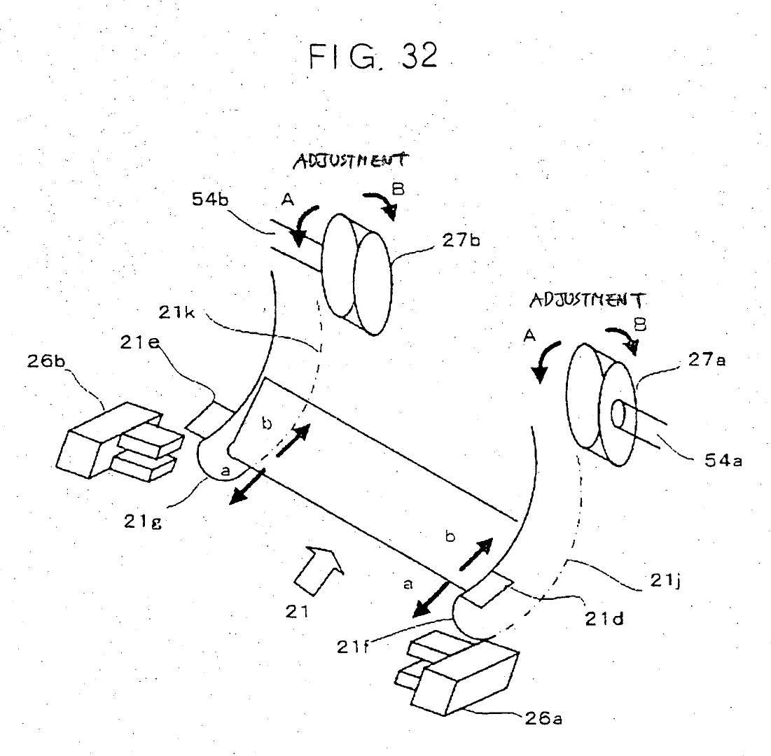

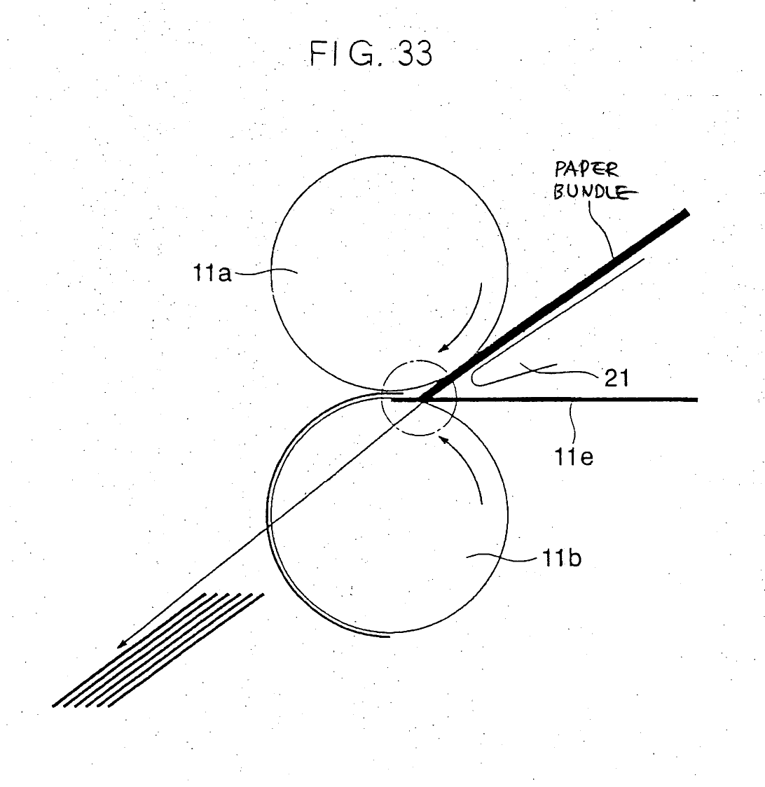

FIGS. 31 and 32 illustrate an adjustment operation of the biasing means of a paper folding device according to the third embodiment. Here, the left biasing means 21 is used here for description.

The drive gears 23a and 23b mesh with the gear portions 21b′ at both ends of the left biasing means 21. The drive gears 23a and 23b are both driven fastened onto a single drive shaft 54, and therefore the left biasing means 21 moves parallel to the same drive shaft 54 by the amount by which the drive shaft 54 rotates. The drive shaft 54 is linked with a driven pulley 42a, a drive pulley 40, a drive belt 41, a shaft 39, a drive pulley 55, a drive belt 37, and a biasing means left motor 36 (see FIG. 8), and the left biasing means 21 is caused to move by the rotation of the biasing means left motor 36. Here, the drive gear 23b that meshes with one of the gear portions 21b′ at the ends of the left biasing means 21 is capable of positional adjustment with the rotation direction of the other drive gear 23a, and when the drive gear 23b rotationally adjusts in the arrow A direction with respect to the drive gear 23a, a biasing means leading edge rear side 21g is adjusted in an arrow a direction. At this time, a biasing means leading edge front side 21f is not caused to move.

Similarly in FIG. 32, a drive gear 27a meshes with a front side gear portion 21j of the left biasing means 21, and a drive gear 27b meshes with a rear side gear portion 21k. The drive gears 27a and 27b are fastened to and driven by different drive shafts 54a and 54b, and therefore the left biasing means 21 moves by the amount of movement of the drive shafts 54a and 54b. Furthermore, the relative positions of the biasing means leading edge front side 21f and the biasing means leading edge rear side 21g changes according to their respective movements. The drive gears 27a and 27b of both ends are linked respectively to the drive pulleys 28a and 28b, the drive pulleys 40a and 40b, the drive belts 41a and 41b, the shafts 39a and 39b, the drive pulleys 55a and 55b, the drive belts 37a and 37b, and the biasing means left motors 36a and 36b, and the left biasing means 21 is caused to move by the rotation of the biasing means left motors 36a and 36b. Further still, light shielding plates 21d and 21e are provided at end portions of the biasing means 21, and biasing means left position sensors 26a and 26b block light at positions where the leading edge of the folding roller 21a makes contact with the lower folding roller 11b of the folding roller pair 11, thereby detecting the position of contact of the folding rollers. The amounts of rotation of the biasing means left motors 36a and 36b are controlled based on information from the biasing means left position sensors 26a and 26b, and adjustment is performed such that the relative positions of the biasing means leading edge front side 21e and the biasing means leading edge rear side 21f become equivalent.

Other portions not particular described are similarly structured and function similarly as the first embodiment.

With the present embodiment, the relative positions of both sides of the biasing means leading edges of the biasing means 20 and 21 can be adjusted, and therefore not only can the movement amounts of the biasing means end portions be made equivalent, but it is also possible to make parallel the relative positions of the lower folding rollers 11b and 12b of the folding roller pairs 11 and 12, which contact the leading edge portions of the biasing means, and the leading edges of the biasing means. Thus, it is possible to prevent skewing and paper misalignment due to one-sided contact to the paper of the biasing means leading edge portions. As a result, the roller pressure F is stable and very accurate folding can be achieved at the targeted positions.

Furthermore, the end drive portions of the biasing means 20 and 21 are driven by different drive sources, the relative positions of both sides of the leading edges of the biasing means are detected by the sensors 26a and 26b, and relative position adjustment can be carried out using the different drive sources, and therefore it becomes possible to perform adjustments in which the movement amounts of end portions of the biasing means during operation of a paper folding machine, relative position adjustments of both sides of the leading edge of the biasing means, and adjustments related to the relative positions of the lower side folding rollers of the folding roller pairs that are brought into contact with the leading edge portions of the biasing means, such that it is possible to continually prevent skewing and paper misalignment due to one-sided contact to the paper of the biasing means leading edge portions regardless of the paper type and number of times of folding. Thus, the roller pressure F is stable and very accurate folding can be achieved at the targeted positions.

### Fourth Embodiment

The following is a description of this embodiment. It should be noted in regard to description of the aforementioned embodiments being substantially applied in the present embodiment that duplicate description thereof is omitted and only portions and characteristics of the present embodiment that are different are described below.

The following is a description of the fourth embodiment. It should be noted that same reference numerals are given to portions that are the same as in the first embodiment and duplicate description is omitted as appropriate.

The present embodiment relates to a finisher provided with a crossing portion that again further folds a paper that has been folded in an accordion shape by the paper folding portion 3 in an accordion shape in a direction orthogonal to the accordion fold. In a finisher provided with such a crossing portion, paper that has been folded in an accordion shape is again folded and therefore when the paper leading edge inserts into the nip of the folding roller pairs 11a and 11b, the paper may become misaligned in a wedge shape as shown in FIG. 33 (in particular the circled portion shows an enlarged view), and when such misalignment occurs, a disparity is created between the outer side length and the inner side length of the paper, and due to this disparity in length, the fold of the next fold cannot be folded neatly, which may result in folding a box shape or folding a Z shape. The present embodiment is devised to handle such phenomena.

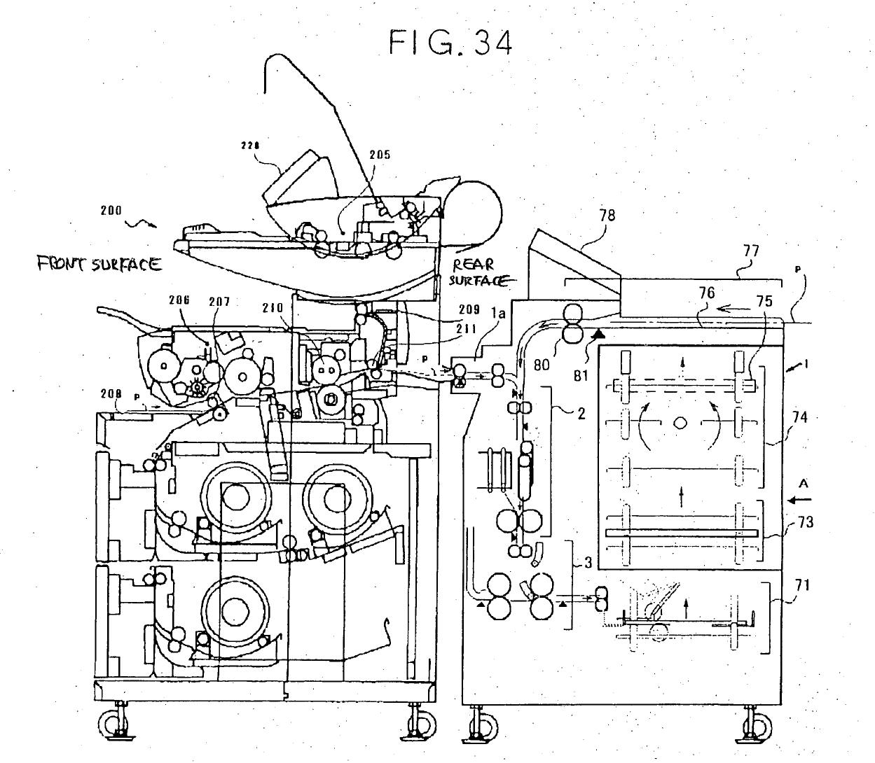

A system according to the present embodiment includes a paper folding device 1 linked to a rear surface side of a copying machine main unit 200 in the same manner as the first embodiment. As shown in FIG. 34, the paper folding device 1 according to the present embodiment is mainly constituted by an end surface folding portion 2 that folds an end surface of a paper carried in by linking portion 1a, a paper folding portion 3 that is arranged in a down stream carrying direction side of the end surface folding portion 2 and folds paper in an accordion shape, a carry switching portion 71 that switches a direction in which the paper folded in an accordion shape is carried, a cross folding portion 72 for folding paper whose carry direction has been switched, an inversing portion 73 that inverts the back and front of sheets folded to an A4 size by the cross folding portion 72, a rotation portion 74 for rotating paper that has been inverted, and a tray 75. Furthermore, the paper folding device 1 is provided with a manual loading portion 77 constituted by a manual feed platform 76 as a second paper carry entrance so that paper can be inserted without passing through the copying machine main unit 200 (offline) and can also carry out folding processes. Furthermore, online operations for carrying out folding processes on paper carried in from the copying machine main unit 200 are carried out from an operation portion 220 provided at the copying machine main unit 200, and offline operations for carrying out folding processes on paper inserted from the manual loading portion 77 of the paper folding device 1 are carried out from an operation portion 78 provided at the paper folding device 1.

For online operations, paper size, folding type, and other settings are performed at the operation portion 220. Next, paper is loaded in the manual feed platform 208 arranged under the image reading apparatus 205. This paper is temporarily stopped by a register roller 207 then fed into an image forming unit 206 with an appropriate timing. The image forming unit 206 is a commonly known device that forms a latent image on an unshown photosensitive body corresponding to image data, then this latent image is developed using toner, the toner is transferred to the paper and fixed by a fixing apparatus 210. When a recorded sheet on which toner has been fixed by the fixing apparatus 210 is to undergo paper folding, the recorded sheet is discharged to the paper folding device 1 by a recorded sheet discharge roller 211. And when folding is not to be carried out, the paper is discharged to inside a main unit cylinder by an upper discharge roller 209 guided by an unshown switching claw.

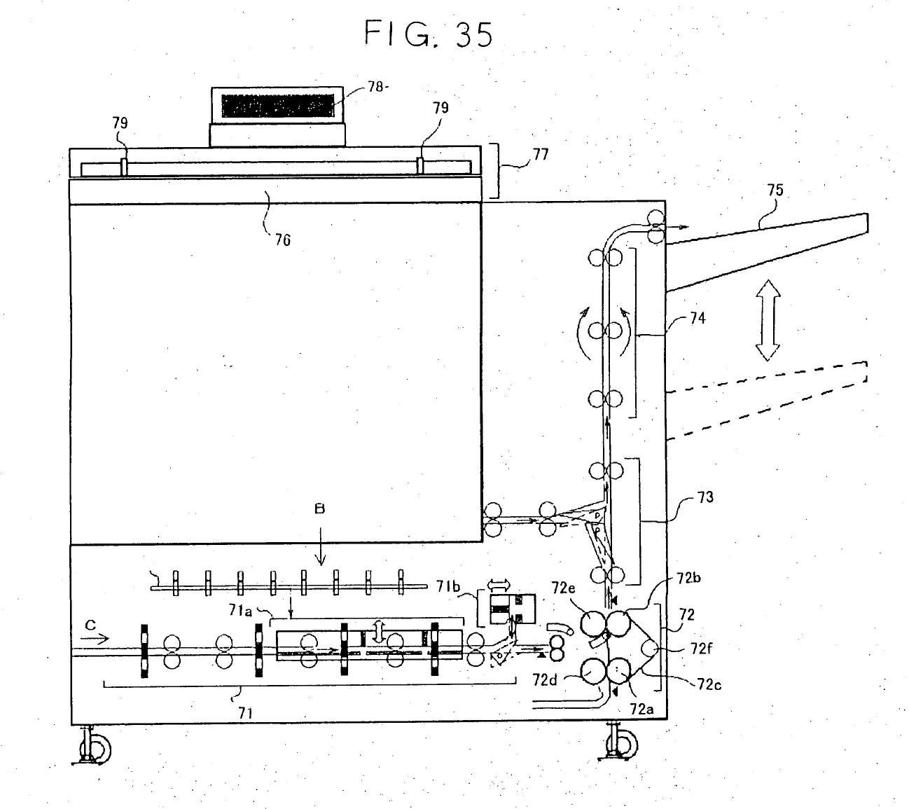

When paper is to be folded, paper is sent by the recorded sheet discharge roller 211 to the paper folding device 1, then sent to the end surface folding portion 2 passing through the linking portion 1a. When folding an end surface of a paper, an end surface of a paper leading edge is folded by the end surface folding portion 2. At this time, the end surface folding portion 2 folds the paper end surface while being carried. Paper that has had the end surface of its leading edge folded by the end surface folding portion 2 is folded into an accordion shape in the carrying direction at the paper folding portion 3 and sent to the carry switching portion 71. Paper folded into an accordion shape that has been sent to the carry switching portion 71 undergoes skew correction by a skew correction portion 71a as shown in FIG. 35, which shows a view along the A direction in FIG. 34, and when perforation is required, the accordion folded paper is perforated by a punch 71b and the paper is sent to the cross folding portion 72.

Accordion folded paper that is sent to the cross folding portion 72 is again folded into an accordion shape in a direction orthogonal to the folding direction of the accordion folding, and folded into an A4 size. Except for the belt 72c provided at the lower side folding rollers 72a and 72b, this folding mechanism is fundamentally the same in the first embodiment. Accordingly, the lower side folding rollers 72a and 72b correspond to the lower side folding rollers 11b and 12b, and the upper side folding rollers 72d and 72e correspond to the upper side folding rollers 11a and 12a. That is, the folding rollers 72a, 72b, 72d, and 72e are equivalent to the folding roller pairs 11 and 12 in the first embodiment, and the belt 72c is wound around the pressure applying side folding rollers 72a and 72b in a tensioned state due to a tension roller 72f.

Paper that has been folded into an A4 size has its transfer side facing down when discharged to the tray 75 and, depending on the folding type, the paper is inverted by the inversing portion 73 then rotated 900 left or right by the rotation portion 74 so that its orientation as seen in the drawing matches up when discharged to the tray 75 and so that folding types of paper have the same orientation or the like so that orientation-aligned papers are discharged to the tray 9.

In the offline operation, side fences 15 on the manual feeding platform 76 align side fences 79 shown in FIG. 35 to the width of the paper targeted for folding and paper that is loaded onto the manual feeding platform 76 is inserted in the arrow direction shown in FIG. 29. Then, the paper is detected by a paper size sensor 81, manual feeding carry roller pair 80 rotates with a predetermined timing, the paper P is gripped and temporarily stops. On the other hand, the user can perform settings such as paper size and folding type at the operation portion 78, then press a start button. Then, the manual feeding carry roller pair 80 again rotates, the paper P is carried in the arrow direction, and the paper P is sent to the end surface folding portion 2. After this, the operation is the same as online operation.

Other portions not particular described are similarly structured and function similarly as the first embodiment.

When the folding belt 72c is wound around the lower side folding rollers 72a and 72b in this way, resistance is reduced when the paper bundle leading edge makes contact with the folding belt 11e and wedge shaped misalignment can be prevented. Consequently, it is possible to keep to a minimum the leading edge of accordion folded paper becoming folded in a box shape or becoming folding in a Σ shape.

### Fifth Embodiment

The following is a description of this embodiment. It should be noted in regard to description of the aforementioned embodiments being substantially applied in the present embodiment that duplicate description thereof is omitted and only portions and characteristics of the present embodiment that are different are described below.

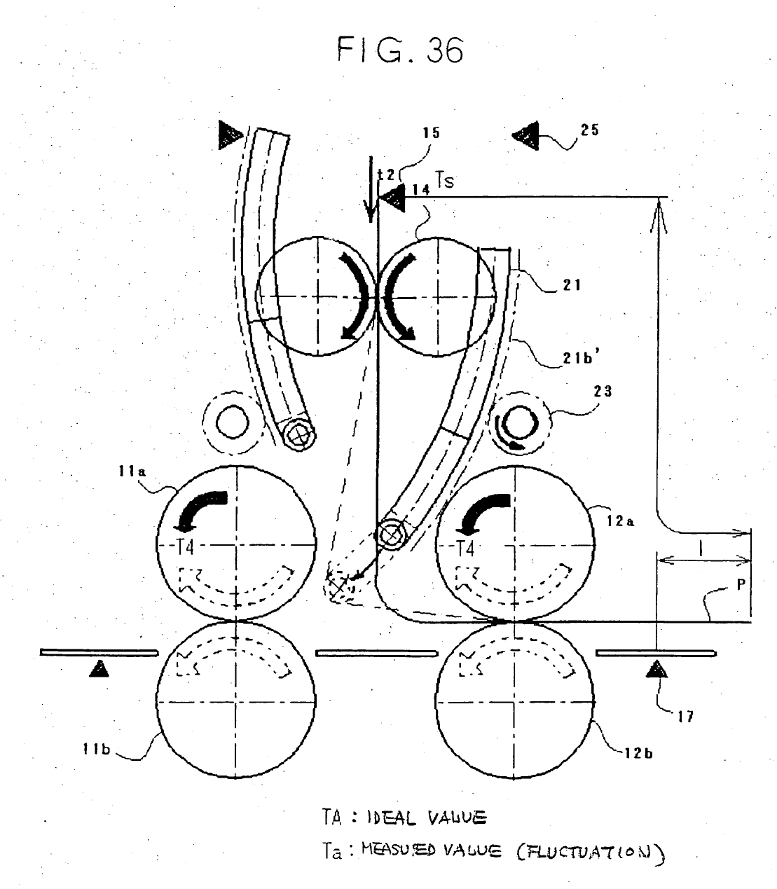

The present embodiment relates to a finisher that automatically adjusts a folding width of a first surface. As shown in FIG. 36, a time Ta, in which the paper leading edge enters the nip of the right folding rollers 12a and 12b and the leading edge detection sensor 17 goes ON, when performing accordion folding varies due to such factors as the curl direction of the paper and the thickness of the paper bundle. Accordingly, the length 1 from the folding width right detection sensor 17 to the stop position of the paper leading edge is uneven, and the unevenness of the length 1 affects the length of the immediately subsequent folding position. Thus, in the present embodiment, a time Ta is measured in which the paper leading edge enters the nip of the right folding rollers 12a and 12b and the folding width right detection sensor 17 goes ON, and a timing T4 for turning OFF and stopping the folding motor 30 is corrected based on the measured time Ta, and therefore the length from the folding width right detection sensor 17 to the stop position of the paper leading edge is kept constant.

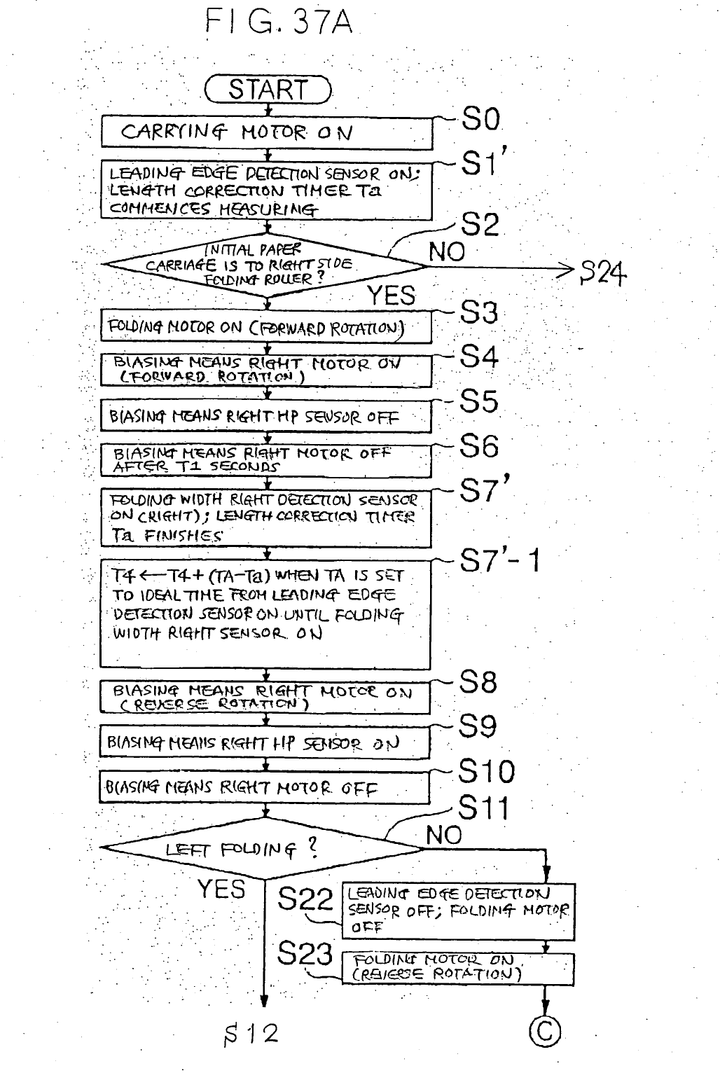

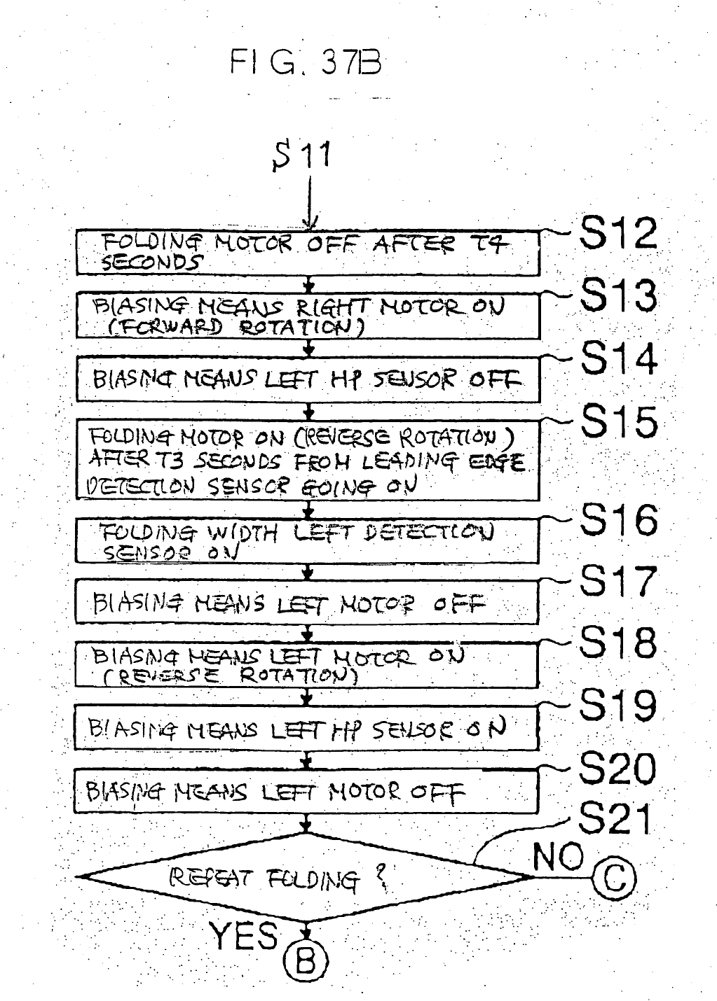

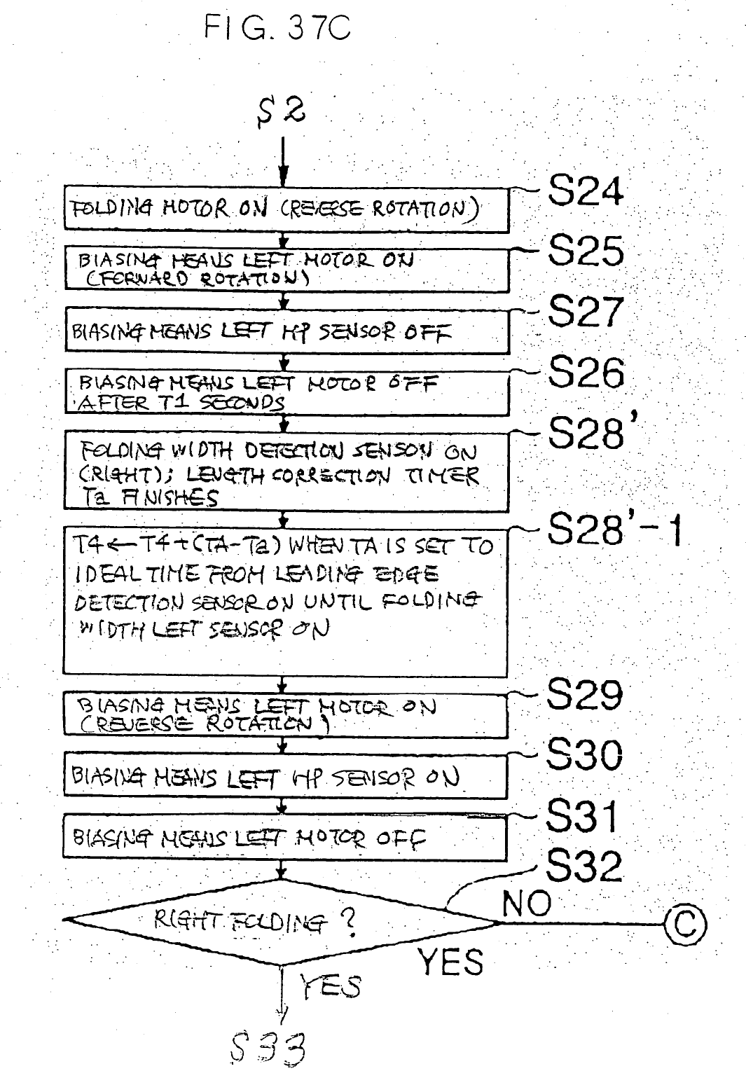

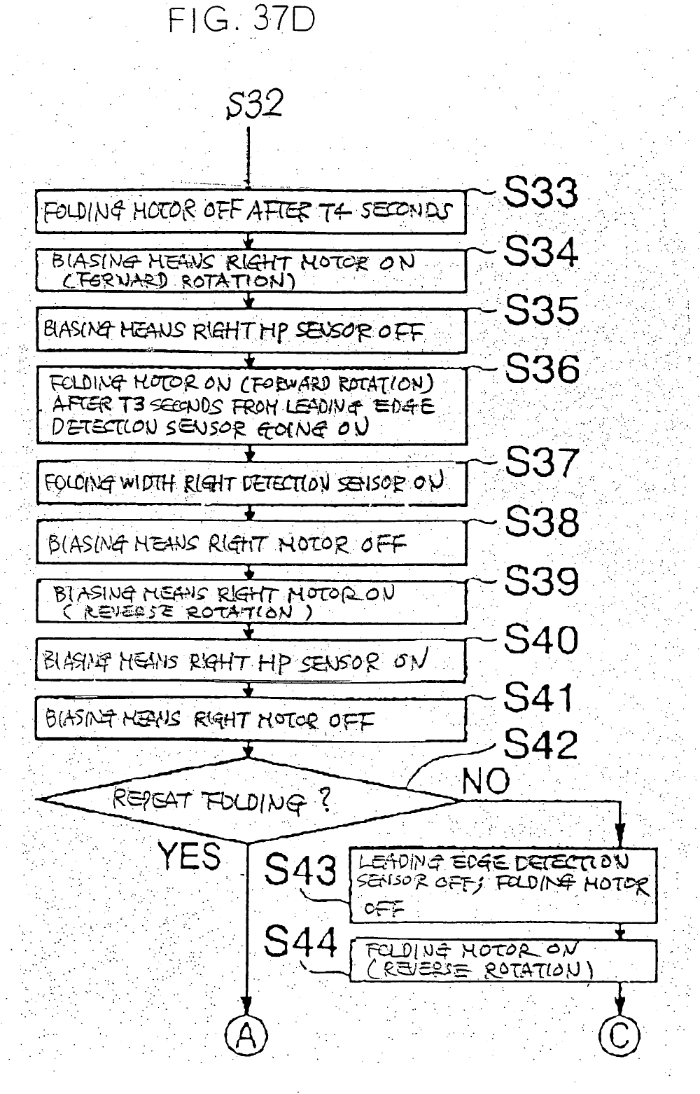

The processing procedure of this time is shown in the flowchart of FIGS. 37A to 37D. In this flowchart, only steps S1, S7, and S28 are different from the first embodiment illustrated in FIGS. 13A to 13D, and therefore description predominantly concerns the points of difference and duplicate description is omitted as appropriate.

In FIGS. 37A to 37D, when a signal indicating paper folding is inputted from the main unit operation portion 201 shown in FIG. 12, the signal is sent to the paper folding controller 100 via the main unit control board 202. In this case, the flowchart of FIG. 37A starts at the paper folding device 1 side, the carrying motor 52 of FIG. 8 goes ON, and the carry roller pair 14 of FIG. 4 begins to rotate in the arrow direction (step S0). Next, paper is sent from the copying machine main unit 200, the leading edge of the paper passes the leading edge detection sensor 15, and an ON signal of the leading edge detection sensor 15 is inputted to the paper folding controller 100. At this time, the length correction timer Ta starts and measuring commences (step S1′). Next, a determination is made as to whether or not the initial paper carrying according to the paper folding type signal inputted from the main unit control portion 201 of FIG. 12 is a paper folding type in which the paper enters the right side folding rollers 12 (step S2). If the paper folding type is one that enters the right side folding rollers 12, the folding motor 30 of FIG. 8 turns ON and commences to rotate in the arrow direction of FIG. 4 (here this is forward rotation) (step S3), then the biasing means right motor 43 of FIG. 8 turns ON, and the right biasing means 20 of FIG. 4 commences to move from the solid line position toward the dashed line position (the rotation direction is forward at this time) (step S4).

At this time, the biasing means right HP sensor 24 goes OFF (step S5) and, after a drive time T1 in which the right biasing means 20 reaches the dashed line position from the solid line position, the biasing means right motor 43 goes OFF (step S6). At this time, as shown in FIG. 4, the roller 20a of the leading edge of the right biasing means 20 and the lower folding roller 12b do not contact and the right biasing means 20 is caused to stop in a state in which there is a slight gap. In this state, the leading edge of the paper P enters the nip of the right side folding roller pair 12 as shown in FIG. 4 and the folding width right detection sensor 17 goes on. At this time, the length correction timer Ta of step S1 stops (step S7′). Further still, if an ideal time from the leading edge detection sensor 14 going ON until the folding width right sensor 17 going ON is given as TA, the timing T4 for turning OFF and stopping the folding motor 30 is corrected as follows:
T4←T4+(TA−Ta)

After this, in order to return the right biasing means 20 to the standby position, the biasing means right motor 43 goes ON in the reverse rotation direction (step S8), the biasing means right HP sensor 24 goes ON (step S9), the biasing means right motor 43 goes OFF (step S10), and the right biasing means 20 returns to a standby state at the solid line position of FIG. 4. Then, the processes of step S11 onward are executed.

On the other hand, if the initial paper carry at step S2 is not a paper folding type in which the paper enters the right side folding rollers 12, then the procedure moves to step S24 and the same processes as in the aforementioned steps S7′ and S7-1 are carried out for the left side biasing means 21 in steps S28′ and 28′-1 to perform correction of T4, and the processes of step S29 onward are executed.

Other steps are carried out in the same manner as the processing procedure of FIG. 12.

When processing in this manner, the time Ta is measured in which the paper leading edge enters the nip of the right folding rollers 12a and 12b and the leading edge detection sensor 17 goes ON, and a timing T4 for turning OFF and stopping the folding motor 30 is corrected based on the measured time Ta, and therefore the length 1 from the leading edge detection sensor 17 to the stop position of the paper leading edge is kept constant. That is, unevenness in the first surface folding width can be reduced. It must be emphasized that this operation can also be carried out in the same manner for second surfaces other than the first surface fold in which folds do not overlap. It should be noted that the same is true for the left folding rollers 11a and 11b.

### Sixth Embodiment

The following is a description of this embodiment. It should be noted in regard to description of the aforementioned embodiments being substantially applied in the present embodiment that duplicate description thereof is omitted and only portions and characteristics of the present embodiment that are different are described below.

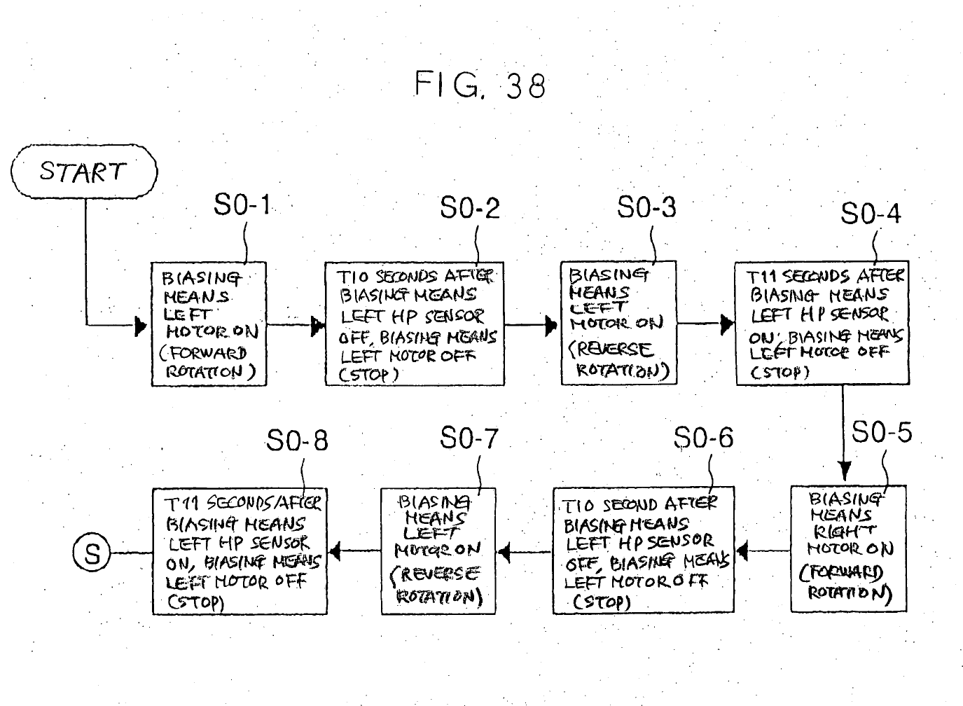

In the paper folding device 1 of the present embodiment, when a signal indicating paper folding is inputted from the main unit operation portion 201 shown in FIG. 12, necessary information such as paper type is appended and the signal is sent to the paper folding controller 10 via the main unit control board 202. In this case, the flowchart of FIG. 38 starts at the paper folding device 100 side, the biasing means left motor 36 of FIG. 8 goes ON in the forward rotation direction (step S0-1), then, after the biasing means left HP sensor 25 goes OFF, the biasing means left motor 36 goes OFF after T10 seconds (step S0-2), after which the biasing means left motor 36 goes on in the reverse rotation direction (step S0-3), then, after the biasing means left HP sensor 25 goes ON, the biasing means left motor 36 goes OFF after T11 seconds (step S0-4), thereby adjusting the standby position of the left biasing means 21.

Next, adjustment of the standby position of the right biasing means 20 is carried out in the same manner as the adjustment for the left biasing means 21 using the biasing means right motor 43 and the biasing means right HP sensor 24 via the flowchart steps S0-5 to S0-8. The standby positions of the biasing means 20 and 21 are determined according to various sensors and information by the paper folding controller 10 of FIG. 11 obtaining necessary information such as folding type, paper size, and paper type from the main unit control board 202. After this, a jump is made to S, and the carry motor 52 of FIG. 8 goes ON and the carrying roller pair 14 of FIG. 4 commences rotating in the arrow direction (step S0).

Following this, the operations of FIGS. 13A to 13D and 14A to 14D are carried out.

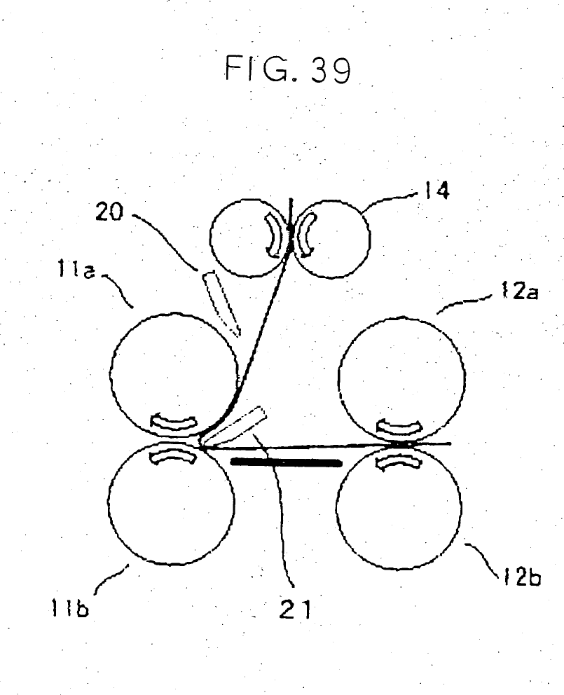

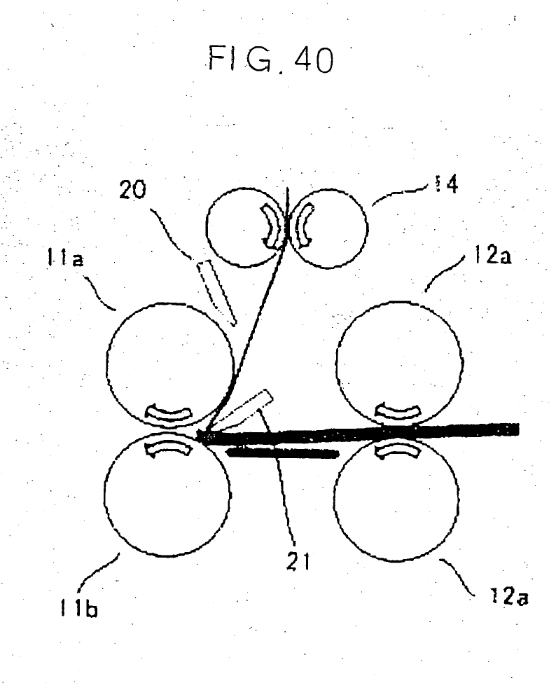

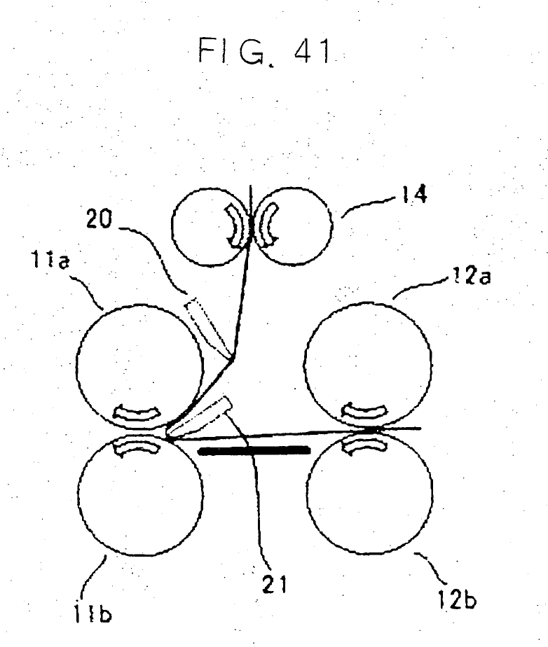

On the other hand, in the present embodiment, although the tension on the paper is also affected by the aforementioned pressure F, a biasing means is used on a reverse side to that of the biasing means used actively on the folding side. For example, when the paper P is caused to enter the nip of the left folding roller pair 11 (11a and 11b) by a left shifting means 21 as shown in FIG. 39, tension can also be applied to the paper P by a right shifting means 20 as shown in FIG. 41. This also enables the angle at which the paper P is wound onto the upper side folding rollers 11a to be adjusted. That is, the position of a paper guide 21 of the right shifting means 20 is set appropriately, and the standby position of the right shifting means 20 is set so as to achieve a desired tension. The reverse operation is used in the case of the left shifting means 21.

In regard to the winding angle, when a single sheet is folded multiple times for example, the feeding position of the paper P at the nip changes in response to increased numbers of times of folding, and therefore the aforementioned adjustment is necessary and this also changes due to the abrasive force of the paper P, and therefore adjustment is necessary. For this reason, in the present embodiment, when folding a single sheet multiple times, the tension applied to the paper P is reduced in accordance with increases in the number of times of folding, and the tension on the paper P is reduced for paper P having little abrasive force compared to paper having strong abrasive force. Tension adjustments can be made using the standby positions of the biasing means 20 and 21, and therefore when reducing the tension, the biasing means is moved to a position backward, that is to say, a direction away from the folding rollers compared to when increasing the tension. The amount of shifting is stored in advance as a table for example in an unshown RAM of the paper folding controller 10, and a CPU of the paper folding controller 10 makes judgments and carries out control according to information from the main unit control portion 201.

It should be noted and emphasized in regard to the present embodiment that a member that applies tension may be provided separate to the case of using the biasing means 20 and 21. Furthermore, the winding onto the folding rollers 11 and 12 is carried out by having the paper guides 20a and 21a of the biasing means 20 and 21 push the paper onto the upper side folding rollers 11a and 12a, and therefore the abrasive force is prescribed by the pressing force of the paper of the paper guides 20a and 21a on the upper side folding rollers 11a and 12a.

Accordingly, the positions of the paper guides 20a and 21a can be moved and slippage between the paper P and the upper folding rollers 11a and 12a due to differences in the abrasion coefficient, firmness, and thickness of the paper P can also be adjusted and thus unevenness in folding positions due to thick papers and thin papers as well as unevenness in the folding positions for single folds and muitiple folds can be reduced. As a result, folding functions can be achieved with very high folding accuracy and stability.

The following effects are provided by the present embodiment.

The biasing means applies a constant tension to the paper and with this tension, the paper contacts, is carried by, and folded into the upper side folding rollers on the folding roller pair on the side where the paper is folded, and therefore a loop of paper can be formed close to the folding rollers and the diameter of the thus-formed loop can be reduced, and therefore the resistance is reduced when the loop enters the folding roller nip, and not only is slippage between the paper and the lower side folding rollers greatly reduced, but slippage between the paper and the upper side rollers due to paper contacting the upper side rollers can be greatly reduced, such that accurate folding can be achieved at the targeted positions.

Furthermore, bulging of the paper bundle is reduced as much as possible even when repeated folding occurs and unevenness in the paper loop formation can be reduced when the number of times of folding increases, such that accurate folding can be achieved at the targeted positions. Moreover, a constant tension is applied to the paper to eliminate slackness of the paper, and therefore very accurate folding can be achieved at the targeted positions by accurately bringing the targeted positions into contact with the lower side folding rollers and the upper side folding rollers of the folding roller pairs.

Furthermore, although the tension applied to the paper is also affected by the pressure F as described above, a biasing means is used on a reverse side to that of the biasing means used actively on the folding side, and when the paper enters the nip of the left folding roller pair due to the left shifting means, tension is applied to the paper by the right shifting means such that the angle at which the paper is wound onto the upper side folding roller can be adjusted.

Furthermore, the carry rollers and the two pairs of folding rollers are set in a positional relation of where the paper is brought into contact with the upper side rollers of the folding roller pair on the side where paper is folded in an operation in which the biasing means contacts the lower side folding roller of the folding roller pair on the side where paper is folded, and therefore slippage between the paper and the upper side rollers can be reduced and accurate folding can be achieved at the targeted positions without adding new components.

Furthermore, by providing paper guides so that the paper makes contact with the upper side rollers of the folding roller pair on the side where paper is folded, it becomes possible to achieve contact with the upper side folding rollers and the lower side folding rollers with excellent timing regardless of the positions of the carry roller and the two pairs of folding rollers, and therefore slippage between the paper and the upper/lower rollers at the time of paper contact can be reduced and accurate folding can be achieved at the targeted positions.

Furthermore, since the standby positions of the opposing biasing means also act as paper guides so that the paper contacts upper side folding rollers of the folding roller pair on the side where paper is folded, the aforementioned effect can be achieved without adding new components.

Furthermore, the position of the paper guides, which are provided so that the paper contacts upper side folding rollers of the folding roller pair on the side where paper is folded, can be moved in order to adjust the angle at which the paper winds onto the upper side folding rollers, and therefore slippage between the paper and the upper folding rollers due to differences in the abrasion coefficient, firmness, and thickness of the paper can be adjusted, and the balance of slippage between the paper and the lower folding rollers can be aligned, and therefore accurate folding can be achieved at the targeted positions.

Furthermore, the standby positions of the opposing biasing means, which also act as paper guides so that the paper makes contact with the upper side folding rollers of the folding roller pair on the side where paper is folded, can be changed to enable adjustment of the angle at which the paper winds onto the upper side folding rollers, and therefore the aforementioned effect can be achieved without adding new components.

Furthermore, the position of the paper guides, which are provided so that the paper contacts upper side folding rollers of the folding roller pair on the side where paper is folded, can be changed to enable adjustment of the angle at which the paper winds onto the upper side folding rollers according to paper thickness and the number of times of folding, and therefore variation of the wind on angle to the upper folding roller due to such factors as the paper thickness and the number of times of folding can be eliminated, and slippage between the paper and the upper folding rollers due to such factors as the paper thickness and the number of times of folding can be reduced, thereby enabling accurate folding to be achieved at the targeted positions.

Furthermore, a freely rotatable roller is provided at the leading edge of the paper guides, which are provided so that the paper contacts upper side folding rollers of the folding roller pair on the side where paper is folded, and this roller guides the paper so that the paper makes contact with the upper side folding rollers of the folding roller pair on the side where paper is folded, and therefore carrying resistance is reduced, and the carrying precision can be improved, thereby enabling accurate folding to be achieved at the targeted positions. Furthermore, damage to the paper by the leading edge of the paper guide can be reduced by using the freely rotatable roller, thereby improving the quality of the paper fold finish.

Furthermore, by forming the freely rotatable roller at the leading edge of the paper guides as a single roller having a length greater guided paper width, the pressure on the paper when contact is made between the roller and the paper can be made uniform in the width direction, thereby eliminating rippling in the width direction of the paper and preventing occurrences of winkling. Thus, damage to the paper can be reduced and the quality of the paper fold finish can be improved.

Furthermore, when the freely rotatable roller at the leading edge of the paper guide is configured from a pipe shaped roller and the biasing means also acts as a paper guide, the weight of the biasing means can be reduced, thereby reducing the required torque of the drive motors and enabling reduced costs.

Furthermore, by having the freely rotatable roller at the leading edge of the paper guide support the biasing means in the width direction, warping of the roller is prevented when the roller and paper make contact, and the pressure on the paper can be made uniform in the width direction, thereby eliminating rippling in the width direction of the paper and preventing occurrences of winkling.

Furthermore, by supporting locations that bear the freely rotatable roller at the leading edge of the paper guide using a plurality of shaft bearing members, partial contact of the rollers and the shaft bearing portion with respect to the curvature of the biasing means is prevented, and warping of the roller over time due to uneven wear of the shaft bearing portion is prevented, thereby enabling accurate folding to be achieved at the targeted positions.

It should be noted that the paper folding devices described up until here are devices that fold sheets (recorded sheets) on which an image has been formed having been outputted from a copying machine main unit, but since the copying machine itself is an image forming apparatus provided with an image reading device, it is sufficient for there to be a function of printing and outputting a read image onto a recording sheet. Accordingly, an image forming apparatus of a commonly known system or structure such as an electrophotographic system image forming apparatus or an inkjet system image forming apparatus can be used as the image forming apparatus (image forming portion of a copying machine).

With the present invention, the biasing means contacts the paper at the lower side folding roller of the folding roller pair of the side on which the paper is folded and the paper to be folded is carried and folded, and therefore unevenness in folding positions due to thick papers and thin papers as well as unevenness in the folding positions for single folds and multiple folds are greatly reduced and folding functions with high folding accuracy and stability are achieved.

Furthermore, with the present invention, a tension applying means is provided that applies tension to the paper folded between the folding roller pair and the carry roller pair, and therefore unevenness in folding positions due to thick papers and thin papers as well as unevenness in the folding positions for single folds and multiple folds are greatly reduced and folding functions with high folding accuracy and stability are achieved.

Various modifications will become possible for those skilled in the art after receiving the teachings of the present disclosure without departing from the scope thereof.

What is claimed is:

1. A paper folding device having a function of alternately switching a bending direction to carry out folding continuously a plurality of times, comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means brings the paper into contact with one folding roller of the folding roller pair on a side where the paper folds, and the paper to be folded is carried and folded.

2. The paper folding device as claimed in claim 1, wherein the one folding roller is a roller on a far side from the biasing means that brings paper into contact.

3. The paper folding device as claimed in claim 2, wherein a belt is provided in a tensioned state between rollers on the far side.

4. The paper folding device as claimed in claim 1, wherein a force applying means is provided that applies an elastic force such that a central area of one roller, which is a part of a pair to the first and second folding roller pairs, elastically applies force to another roller on the other side.

5. The paper folding device as claimed in claim 1, comprising a freely rotatable roller at a leading edge of the biasing means, the roller causing the paper to contact one folding roller of the folding roller pair.

6. The paper folding device as claimed in claim 5, wherein the roller is a single roller having a length equal to or greater than a paper width of paper to be folded.

7. The paper folding device as claimed in claim 5, wherein the roller is pipe shaped.

8. The paper folding device as claimed in claim 5, wherein the roller is supported by the biasing means at both end portions in an axial direction.

9. The paper folding device as claimed in claim 8, wherein locations that bear the roller have undergone a fluorine resin coating.

10. The paper folding device as claimed in claim 8, wherein locations that bear the roller are supported by a plurality of shaft bearing members.

11. The paper folding device as claimed in claim 5, wherein when the carry roller pair feeds a paper leading edge to the first or second folding roller pair, the rollers do not contact the first or second folding roller on one side.

12. The paper folding device as claimed in claim 1, wherein the biasing means is constituted by a single sheet of sheet metal and the leading edge portion that contacts the paper is integrally formed in a circular arc shape by bending the sheet metal.

13. The paper folding device as claimed in claim 1, wherein the biasing means is made from a resin material having a low coefficient of abrasion.

14. The paper folding device as claimed in claim 1, wherein a movement trajectory of the biasing means is a circular arc shape.

15. The paper folding device as claimed in claim 1, further comprising:
measuring means for measuring a time until the leading edge of the paper reaches a predetermined position after the leading edge of the paper enters the nip of the folding roller pair, and
stop timing determination means for determining a timing by which drive of the folding roller pair is stopped based on a measurement result of the measuring means.

16. A paper folding device having a function of alternately switching a bending direction to carry out folding continuously a plurality of times, comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the paper is brought into contact with one folding roller of the folding roller pair on a side where paper is folded while the biasing means applies a fixed tension to the paper, and the paper to be folded is carried and folded.

17. The paper folding device as claimed in claim 16, wherein the one folding roller is a roller on a far side from the biasing means that brings paper into contact.

18. The paper folding device as claimed in claim 17, wherein a belt is provided in a tensioned state between rollers on the far side.

19. The paper folding device as claimed in claim 16, wherein a force applying means is provided that applies an elastic force such that a central area of one roller, which is a part of a pair to the first and second folding roller pairs, elastically applies force to another roller on the other side.

20. The paper folding device as claimed in claim 16, comprising a freely rotatable roller at a leading edge of the biasing means, the roller causing the paper to contact one folding roller of the folding roller pair.

21. The paper folding device as claimed in claim 20, wherein the roller is a single roller having a length equal to or greater than a paper width of paper to be folded.

22. The paper folding device as claimed in claim 20, wherein the roller is pipe shaped.

23. The paper folding device as claimed in claim 20, wherein the roller is supported by the biasing means at both end portions in an axial direction.

24. The paper folding device as claimed in claim 23, wherein locations that bear the roller have undergone a fluorine resin coating.

25. The paper folding device as claimed in claim 23, wherein locations that bear the roller are supported by a plurality of shaft bearing members.

26. The paper folding device as claimed in claim 20, wherein when the carry roller pair feeds a paper leading edge to the first or second folding roller pair, the rollers do not contact the first or second folding roller on one side.

27. The paper folding device as claimed in claim 16, wherein the biasing means is constituted by a single sheet of sheet metal and the leading edge portion that contacts the paper is integrally formed in a circular arc shape by bending the sheet metal.

28. The paper folding device as claimed in claim 16, wherein the biasing means is made from a resin material having a low coefficient of abrasion.

29. The paper folding device as claimed in claim 16, wherein a movement trajectory of the biasing means is a circular arc shape.

30. The paper folding device as claimed in claim 16, wherein the tension is applied from a drive portion of the biasing means.

31. The paper folding device as claimed in claim 30, wherein the drive portion drives such that a movement speed of the biasing means is equal to or greater than a movement speed at which the paper slackens.

32. The paper folding device as claimed in claim 31, wherein the drive is performed in a state in which no gap exists between the biasing means leading edge and the paper prior to a biasing means operation.

33. The paper folding device as claimed in claim 16, further comprising:
measuring means for measuring a time until the leading edge of the paper reaches a predetermined position after the leading edge of the paper enters the nip of the folding roller pair, and
stop timing determination means for determining a timing by which drive of the folding roller pair is stopped based on a measurement result of the measuring means.

34. A paper folding device having a function of alternately switching a bending direction to carry out folding continuously a plurality of times, comprising:
first and second pairs of folding roller pairs that bend a paper;
a carry roller pair that feeds the paper to the first or second folding roller pair; and
biasing means for switching a direction in which the paper is bent by the first or second folding roller pair,
wherein both ends of the biasing means are driven so that movement amounts of both ends of the biasing means become equivalent, and the paper is brought into contact with one folding roller of the folding roller pair on a side where paper is folded such that the paper to be folded is carried and folded.

35. The paper folding device as claimed in claim 34, wherein the one folding roller is a roller on a far side from the biasing means that brings paper into contact.

36. The paper folding device as claimed in claim 35, wherein a belt is provided in a tensioned state between rollers on the far side.

37. The paper folding device as claimed in claim 34, wherein a force applying means is provided that applies an elastic force such that a central area of one roller, which is a part of a pair to the first and second folding roller pairs, elastically applies force to another roller on the other side.

38. The paper folding device as claimed in claim 34, comprising a freely rotatable roller at a leading edge of the biasing means, the roller causing the paper to contact one folding roller of the folding roller pair.

39. The paper folding device as claimed in claim 38, wherein the roller is a single roller having a length equal to or greater than a paper width of paper to be folded.

40. The paper folding device as claimed in claim 38, wherein the roller is pipe shaped.

41. The paper folding device as claimed in claim 38, wherein the roller is supported by the biasing means at both end portions in an axial direction.

42. The paper folding device as claimed in claim 41, wherein locations that bear the roller have undergone a fluorine resin coating.

43. The paper folding device as claimed in claim 41, wherein locations that bear the roller are supported by a plurality of shaft bearing members.

44. The paper folding device as claimed in claim 38, wherein when the carry roller pair feeds a paper leading edge to the first or second folding roller pair, the rollers do not contact the first or second folding roller on one side.

45. The paper folding device as claimed in claim 34, wherein the biasing means is constituted by a sheet of sheet metal and the leading edge portion that contacts the paper is integrally formed in a circular arc shape by bending the sheet metal.

46. The paper folding device as claimed in claim 34, wherein the biasing means is made from a resin material having a low coefficient of abrasion.

47. The paper folding device as claimed in claim 34, wherein a movement trajectory of the biasing means is a circular arc shape.

48. The paper folding device as claimed in claim 34, wherein side drive portions of the biasing means are driven by a same drive shaft.

49. The paper folding device as claimed in claim 34, comprising means for adjusting relative positions of both leading edge sides of the biasing means.

50. The paper folding device as claimed in claim 49, wherein the means for adjusting is constituted by different drive sources and position detection means, side drive portions of the biasing means are driven by the different drive sources, relative positions of both leading edge sides of the biasing means are detected by the detection means, and relative position adjustment is carried out using the different drive sources.

51. The paper folding device as claimed in claim 34, further comprising:
measuring means for measuring a time until the leading edge of the paper reaches a predetermined position after the leading edge of the paper enters the nip of the folding roller pair, and
stop timing determination means for determining a timing by which drive of the folding roller pair is stopped based on a measurement result of the measuring means.

52. A paper folding device having a function of alternately switching a bending direction to carry out folding continuously a plurality of times, comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means supports and carries the paper to be folded in a state having a gap equal to or greater than one sheet of paper with respect to one folding roller of the folding roller pair on a side where the paper folds.

53. The paper folding device as claimed in claim 52, wherein when a number of times of folding increases, the biasing means brings the paper into contact with the one folding roller of the folding roller pair and guides the paper to the folding roller pair.

54. The paper folding device as claimed in claim 52, wherein the one folding roller is a roller on a far side from the biasing means that brings paper into contact.

55. The paper folding device as claimed in claim 52, comprising stoppers for maintaining the gap.

56. The paper folding device as claimed in claim 55, wherein the stoppers are constituted by cylindrical collars provided at both ends of portions of a same shaft of the one folding roller portion.

57. The paper folding device as claimed in claim 56, wherein the first and second folding rollers and the collars are made of a same material or a same type material.

58. The paper folding device as claimed in claim 56, wherein the first and second folding rollers are made of metal rollers having a urethane coating and the collars are made of metal rollers.

59. The paper folding device as claimed in claim 52, wherein the biasing means leading edge has a fixed circular arc shape.

60. The paper folding device as claimed in claim 59, wherein a coefficient of abrasion of the circular arc shape surface is set equal to or lower than a coefficient of abrasion between sheets of paper.

61. The paper folding device as claimed in claim 59, wherein the circular arc shape surface has undergone a fluorine resin coating.

62. The paper folding device as claimed in claim 59, wherein the biasing means is provided with pressure applying means that causes the paper to come in contact with the other folding roller of the folding roller pair on a side where the paper folds.

63. The paper folding device as claimed in claim 62, wherein the pressure applying means is a plate spring.

64. A finisher provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means brings the paper into contact with one folding roller of the folding roller pair on a side where the paper folds, and the paper to be folded is carried and folded.

65. A finisher provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means brings the paper into contact with one folding roller of the folding roller pair on a side where the paper folds while applying a fixed tension to the paper, and the paper to be folded is carried and folded.

66. A finisher provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair;
wherein both ends of the biasing means are driven so that movement amounts of become equivalent, and the paper is brought into contact with one folding roller of the folding roller pair on a side where paper is folded such that the paper to be folded is carried and folded.

67. A finisher provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means supports and carries the paper to be folded in a state having a gap equal to or greater than one sheet of paper with respect to one folding roller of the folding roller pair on a side where the paper folds.

68. An image forming apparatus provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means brings the paper into contact with one folding roller of the folding roller pair on a side where the paper folds, and the paper to be folded is carried and folded.

69. An image forming apparatus provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means brings the paper into contact with one folding roller of the folding roller pair on a side where the paper folds while applying a fixed tension to the paper, and the paper to be folded is carried and folded.

70. An image forming apparatus provided with a paper folding device having a function of alternately switching a bending direction to carryout folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein both ends of the biasing means are driven so that movement amounts of both ends of the biasing means become equivalent, and the paper is brought into contact with one folding roller of the folding roller pair on a side where paper is folded such that the paper to be folded is carried and folded.

71. An image forming apparatus provided with a paper folding device having a function of alternately switching a bending direction to carry out folding continuously a plurality of times, the paper folding device comprising:
first and second pairs of folding roller pairs that bend a paper;
a carry roller pair that feeds the paper to the first or second folding roller pair; and
biasing means for switching a direction in which the paper is bent by the first or second folding roller pair,
wherein the biasing means supports and carries the paper to be folded in a state having a gap equal to or greater than one sheet of paper with respect to one folding roller of the folding roller pair on a side where the paper folds.

72. A paper folding device comprising:
a folding roller pair that folds a paper;
a carry roller pair that feeds the paper to the folding roller pair;
biasing means for switching a direction in which the paper is bent by the folding roller pair and folding in the paper; and
tension applying means that applies tension to the paper folded between the folding roller pair and the carry roller pair.

73. The paper folding device as claimed in claim 72, wherein the tension applying means is constituted by the biasing means.

74. The paper folding device as claimed in claim 73, wherein a pair of biasing means is provided, and when one biasing means is carrying out a paper folding operation, another biasing means applies tension to the paper.

75. The paper folding device as claimed in claim 74, wherein the other biasing means is positioned on an upstream side in a paper carrying direction of the one biasing means.

76. The paper folding device as claimed in claim 73, wherein the biasing means applies a fixed tension to the paper, for carrying the paper the tension is used to bring the paper into contact with an upper side folding roller of the folding roller pair on a side where paper is folded, and the paper is folded in a nip of the folding rollers.

77. The paper folding device as claimed in claim 73, wherein standby positions of opposing biasing means function as paper guides so that the paper makes contact with the upper side folding rollers of the folding roller pair on the side where paper is folded.

78. The paper folding device as claimed in claim 77, comprising means for shifting a position of the paper guides.

79. The paper folding device as claimed in claim 78, wherein the means for shifting shifts the position in response to a paper thickness and/or a number of times of folding.

80. The paper folding device as claimed in claim 77, comprising means for shifting standby positions of the paper guides.

81. The paper folding device as claimed in claim 80, wherein the means for shifting shifts the positions in response to a paper thickness and/or a number of times of folding.

82. The paper folding device as claimed in claim 80, wherein the means for shifting shifts the standby positions in a direction to decrease tension on the paper in accordance with an increase in a number of times of folding.

83. The paper folding device as claimed in claim 80, wherein the means for shifting shifts the standby positions in a direction to decrease tension on the paper more for paper having a small abrasive force compared to paper having a large abrasive force.

84. The paper folding device as claimed in claim 77, comprising a freely rotatable roller that contacts the paper at a leading edge portion of the paper guides.

85. The paper folding device as claimed in claim 84, wherein the roller is a single roller having a length equal to or greater than a paper width for guiding.

86. The paper folding device as claimed in claim 85, wherein the roller is a pipe shaped roller.

87. The paper folding device as claimed in claim 84, wherein the roller is supported by the biasing means in a width direction.

88. The paper folding device as claimed in claim 87, wherein a portion that supports the roller has undergone a fluorine resin coating.

89. The paper folding device as claimed in claim 84, wherein locations that bear the roller are supported by a plurality of shaft bearing members.

90. The paper folding device as claimed in claim 89, wherein a portion that supports the roller has undergone a fluorine resin coating.

91. The paper folding device as claimed in claim 72, wherein the biasing means is made from a resin material having a low coefficient of abrasion.

92. A finisher provided with a paper folding device, the paper folding device comprising:
a folding roller pair that folds a paper;
a carry roller pair that feeds the paper to the folding roller pair;
biasing means for switching a direction in which the paper is bent by the folding roller pair and for folding in the paper; and
tension applying means that applies tension to the paper folded between the folding roller pair and the carry roller pair.

93. An image forming apparatus provided with a paper folding device, the paper folding device comprising:
a folding roller pair that folds a paper;
a carry roller pair that feeds the paper to the folding roller pair;
biasing means for switching a direction in which the paper is bent by the folding roller pair and for folding in the paper; and
tension applying means that applies tension to the paper folded between the folding roller pair and the carry roller pair.
